(19) United States
(12) Patent Application Publication
(10) Pub. No.: US 2004/0062989 A1
(43) Pub. Date: Apr. 1, 2004

(54) Binding agent for electrode of electrochemical element and electrode

(76) Inventors: Yoshiyuki Ueno, Kyoto-shi (JP); Satoshi Murahashi, Kyoto-shi (JP); Katsufumi Yamada, Kyoto-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/415,890

(22) PCT Filed: Nov. 12, 2001
(86) PCT No.: PCT/JP01/09863

(30) Foreign Application Priority Data
Nov. 10, 2000 (JP) 2000-343133

(51) Int. Cl. H01M 4/62; B29C 41/46; B29C 43/02

(52) U.S. Cl. 429/217; 252/182.1; 264/319

(57) ABSTRACT

The invention relates to a binder for an electrode material of an electrochemical device, said binder comprising an aqueous dispersion (I) containing a water-dispersible resin; (I) containing at least one of a thermoreversible thickening vinylic polymer (A) having reversibility of hydrophilicity and hydrophobicity at a certain transition temperature (T) and a water-dispersible resin (B) having a fluorine atom-containing unit; an electrode material dispersion for an electrochemical device, which comprises the said binder and an electrode material (E); an electrode for an electrochemical device, formed from said electrode material dispersion; and a primary cell, a secondary cell, an aluminum electrolytic capacitor or an electric double layer capacitor, which has said electrode.

### TECHNICAL FIELD

The present invention relates to a binder and an electrode material dispersion, which are to be used in the production of electrodes for electrochemical devices, and to such electrodes.

### BACKGROUND ART

Regarding the binders, for electrodes to be used in electrochemical devices, such as primary cells, secondary cells, aluminum electrolytic capacitors and electric double layer capacitors, proposals have been made that binder compositions comprising an aqueous dispersion (e.g. aqueous dispersion of a styrene-butadiene resin) and a thickener (e.g. carboxymethylcellulose, polyvinyl alcohol) be used for providing the electrodes to be used in electrochemical devices with a sufficient level of void fraction (Japanese Kokai Publication Hei-05-74461, Japanese Kokai Publication Hei-02-66918).

A binder comprising a solution of a fluorine atom-containing monomer-based resin in a nonaqueous organic solvent, for example a solution containing a perfluoroethylene-based copolymer in a nonaqueous organic solvent, has also been proposed for the purpose of improving the electrode strength (e.g. Japanese Kokai Publication Hei-10-298386).

### SUMMARY OF THE INVENTION

It is an object of the present invention to provide a binder capable of giving electrode material dispersions improved in applicability.

Another object of the invention is to provide a binder capable of giving electrode material dispersions with which drying shrinkage in the process of electrode production can be prevented and electrodes having a high void fraction can be formed.

A further object of the invention is to provide an electrode material dispersion which hardly causes environmental pollution and is highly safe.

Another object of the invention is to provide an electrode material dispersion which hardly allows the formation of streaks and the like on the coated surface.

A still other object of the invention is to provide an electrode increased in electrode strength.

Another object of the invention is to provide an electrochemical device in which short circuiting hardly occurs and which has a prolonged service life.

A further object of the invention is to provide an electrochemical device satisfactory in discharge voltage, discharge electricity quantity and electrostatic capacity.

The present inventor made intensive investigations to accomplish the above objects and, as a result, found a binder for an electrode material of an electrochemical device, said binder comprising an aqueous dispersion (I) containing a water-dispersible resin; (I) containing at least one of a thermoreversible thickening vinylic polymer (A) having reversibility of hydrophilicity and hydrophobicity at a certain transition temperature (T) and a water-dispersible resin (B) having a fluorine atom-containing unit. Based on such and other findings, the present invention has now been completed.

### BRIEF DESCRIPTION OF THE DRAWINGS

FIG. 1 is a schematic representation, in cross section, of a lithium secondary cells produced in Examples.

FIG. 2 is a schematic representation, in cross section, of an electric double layer capacitor produced in Examples.

### EXPLANATIONS OF NUMERALS

1—Cathode

2—Anode

3—Electrolite

4—Current collector

5—Separator

6—Cell can

7—Polarizable electrode

8—Separator

9—Conductive substrate

10—Electrolysis solution

11—Case

12—Lead wire

### DETAILED DISCLOSURE OF THE INVENTION

Heat-Reversible Thickener (A)

The transition temperature (T) of (A) to be used in a preferred aspect of the present invention can be determined by gradually heating (1° C./min) an aqueous solution containing 1% by weight of the solid matter of (A) and measuring the temperature at which the aqueous solution begins to become turbid by a visual check.

The transition temperature T of (A) is generally not lower than 20° C., preferably 30 to 95° C., more preferably 60 to 80° C. When T is not lower than 20° C., the viscosity of an electrode material dispersion containing the binder comprising (A) will not become excessively high, hence the dispersion can be handled with ease. Generally, T should be higher by at least 5° C. than the temperature at which the electrode material dispersion is molded or applied.

The thickening ability of (A) is heat-reversible, and the fact that the thickening effect of (A) is heat-reversible can be confirmed by cooling the aqueous solution that has become turbid in the above-mentioned measurement to a temperature below T° C. and, after the thus-caused disappearance of the turbidity, warming the aqueous solution again to a temperature above T° C., whereupon the solution again becomes turbid.

The thickener (A) includes homopolymers of a vinyl monomer (a) providing a heat-reversible thickening ability, copolymers of two or more (a), and copolymers of a monomer (a) and another monomer (b).

The monomer (a) is a vinyl monomer providing a heat-reversible thickening ability.

The monomer (a) includes, among others:

(a1) (Meth)acrylates (which include acrylates and methacrylates; hereinafter the same shall apply) of an alkylene oxide [hereinafter referred to as “AO” for short; containing 2 to 4 carbon atoms (hereinafter referred to as “C2-4” for short); e.g. ethylene oxide (EO), 1,2-propylene oxide (PO), 1,2-, 2,3-, 1,3- or 1,4-butylene oxide] adduct of cyclic amine (number of moles of AO added being 1 to 40);

morpholinoethyl (meth)acrylate, those ones described in Japanese Kokai Publication Hei-06-9848, etc.;

(a2) (Meth)acrylates of an AO (C2-4) adducts (number of moles of AO added being 1 to 40) of C5-18 acyclic amine (e.g. mono- or dialkylamine);

diisopropylaminoethyl (meth)acrylate, etc.;

(a3) N-Alkyl- or alkoxyalkyl (meth) acrylamides (C3-6 in total in the substituent(s) on N);

N-isopropyl(meth)acrylamide,

N-methoxypropyl(meth)acrylamide, those ones described in Japanese Kokai Publication Hei-01-14276, etc.:

(a4) N,N-Dialkyl- or di(alkoxyalkyl) (meth)acrylamides (C2-8 in total in the substituents on N);

N,N-diethyl(meth)acrylamide, those ones described in Japanese Kokai Publication Sho-60-233184, etc.;

(a5) N-(Meth)acryloyl-heterocyclic amines; N-(meth)acryloylpyrrolidine, N-(meth)acryloylmorpholine, etc.;

(a6) Polyiminoethylene (degree of polymerization: 2 to 50) group-containing vinyl monomers;

tetraethyleneimine mono (meth) acrylamide, those ones described in Japanese Kokai Publication Hei-09-12781, etc.;

(a7) Mono(meth)acrylates of polyoxyalkylene (C2-4 in the alkylene group; degree of polymerization: 3 to 40) diols or monohydrocarbyl (e.g. C1-8 alkyl) ethers thereof; tetraethylene glycol monoethyl ether mono(meth)acrylate, pentaethylene glycol monobutyl ether mono(meth)acrylate, trioxypropylene-tetraoxyethylene glycol monomethyl ether mono (meth) acrylate, mono (meth) acrylate of EO (6 moles) adduct of tetrapropylene glycol, etc.;

(a8) Monovinylphenyl ethers of polyoxyalkylene (C2-4 in the alkylene group; degree of polymerization: 3 to 40) diols or monohydrocarbyl (e.g. C1-8 alkyl) ethers thereof; tetraethylene glycol monomethyl ether monovinylphenyl ether, pentaethylene glycol monoethyl ether monovinylphenyl ether, pentaoxypropylene-tetraoxyethylene glycol monomethyl ether monovinylphenyl ether, monovinylphenyl ether of EO (8 moles) adduct of tetrapropylene glycol, etc.; and

(a9) Alkyl (C1-6) vinyl ethers; methyl vinyl ether, etc.

Preferred in view of their ability to provide a good thickening ability among the monomers (a) are one or more monomers selected from among (a1) to (a8), more preferably from among (a1) to (a5), most preferably from among (a1) and (a5), in particular from among morpholinoethyl (meth)acrylate and N-(meth)acryloylpyrrolidine.

The monomer (b) copolymerizable with (a) includes:

(b1) Nonionic Monomers:

(b11) (Meth)acrylic Ester Monomers:

(b11-1) Hydrocarbyl (C1-22) (meth)acrylates, e.g. (cyclo)alkyl (meth)acrylates [methyl (meth)acrylate, ethyl (meth)acrylate, n- and iso-butyl (meth)acrylate, cyclohexyl (meth)acrylate, 2-ethylhexyl (meth)acrylate, isodecyl (meth)acrylate, lauryl (meth)acrylate, octadecyl (meth)acrylate, etc.]; aromatic ring-containing (meth)acrylates [benzyl (meth)acrylate, phenylethyl (meth)acrylate, etc.];

(b11-2) Polyhydric alcohol (dihydric to hexahydric or still more polyhydric; OH equivalent 30 to 600) (meth) acrylates, e.g. alkylene glycol or dialkylene glycol (C2-4 in each alkylene group) mono(meth)acrylates [2-hydroxyethyl (meth)acrylate, 2-hydroxypropyl (meth)acrylate, diethylene glycol mono (meth) acrylate]; (poly) glycerol (degree of polymerization 1 to 4) mono(meth)acrylates; polyfunctional (meth)acrylates [(poly)ethylene glycol (degree of polymerization 1 to 100) di(meth)acrylate, (poly)propylene glycol (degree of polymerization 1 to 100) di(meth)acrylate, 2,2-bis(4-hydroxyethoxyphenyl)propane di(meth)acrylate, trimethylolpropane tri(meth)acrylate, etc.];

(b12) (Meth)acrylamide Monomers:

(meth) acrylamide, and (meth) acrylamide derivatives other than (a3) to (a6) [N-methylol(meth)acrylamide, diacetone acrylamide, etc.];

(b13) Cyano Group-Containing Monomers:

(meth)acrylonitrile, 2-cyanoethyl (meth)acrylate, 2-cyanoethylacrylamide, etc.;

(b14) Styrenic Monomers:

styrene and C7-18 styrene derivatives [α-methylstyrene, vinyltoluene, p-hydroxystyene, divinylbenzene, etc.];

(b15) Diene Monomers:

C4-12 alkadienes [butadiene, isoprene, chloroprene, etc.];

(b16) Alkenyl Ester Monomers:

carboxylic acid (C2-12) vinyl esters [vinyl acetate, vinyl propionate, vinylbutyrate, vinyloctanoate, etc.], carboxylic acid (C2-12) (meth)allyl esters [(meth)allyl acetate, (meth)allyl propionate, (meth)allyl octanoate, etc.];

(b17) Epoxy Group-Containing Monomers:

glycidyl (meth)acrylate, (meth)allyl glycidyl ether, etc.;

(b18) Monoolefins:

C2-12 monoolefins [ethylene, propylene, 1-butene, 1-octene, 1-dodecene, etc.];

(b19) Halogen Atom-Containing Monomers:

chlorine, bromine, fluorine or iodine atom-containing monomers, e.g. vinyl chloride, vinylidene chloride, those ones described later under (f), etc.;

(b110) Heterocycle-Containing Monomers:

N-vinyl-substituted monomers [N-vinyl-2-pyrrolidone, N-vinylthiopyrrolidone, N-vinylsuccinimide, etc.], N-methylolmaleimide, etc.;

(b111) Unsaturated Dibasic Acid Dialkyl Esters:

maleic acid di(C1-8) alkyl esters, itaconic acid di(C1-8) alkyl esters, etc.;

(b112) Silyl Group-Containing Monomers:

3-trimethoxysilylpropyl (meth)acrylate etc.;

(b2) Anionic Monomers:

(b21) Monocarboxylic Acid Monomers:

(meth)acrylic acid, crotonic acid, maleic acid mono(C1-8)alkyl esters, itaconic acid mono(C1-8)alkyl esters, vinylbenzoic acid, etc.;

(b22) Dicarboxylic Acid Monomers:

maleic acid (anhydride), fumaric acid, itaconic acid, etc.;

(b23) Sulfonic Acid Monomers:

alkenesulfonicacids (vinylsulfonic acid, (meth)allylsulfonic acid, etc.), aromatic sulfonic acids (styrenesulfonic acid etc.), sulfonic acid group-containing unsaturated esters [alkyl (C1-10) (meth)allyl sulfosuccinate, sulfoalkyl (C2-6) (meth)acrylates, etc.];

(b24) Sulfate Ester Monomers:

(meth)acryloylpolyoxyalkylene (C2-4 in each alkylene group; degree of polymerization 2 to 15) sulfate esters etc.;

(b25) Salts of the above-mentioned anionic monomers [alkali metal salts such as sodium salt and potassium salt, amine salts such as triethanolamine salts, quaternary ammonium salts such as tetra(C4-18)alkylammonium salts], etc.;

(b3) Cationic Monomers:

(b31) Primary Amino Group-Containing Monomers:

C3-6 Alkenylamines [(meth)allylamine, crotylamine, etc.], aminoalkyl (C2-6) (meth)acrylates [aminoethyl (meth)acrylate etc.], vinylaniline, p-aminostyrene;

(b32) Secondary Amino Group-Containing Monomers:

Alkyl(C1-6)aminoalkyl(C2-6) (meth)acrylates [tert-butylaminoethyl (meth)acrylate, methylaminoethyl (meth)acrylate, etc.], C6-12 dialkenylamines [di(meth)allylamine etc.];

(b33) Tertiary Amino Group-Containing Monomers:

Dialkyl(C2-4)aminoalkyl(C2-6) (meth)acrylates [dimethylaminoethyl (meth)acrylate, diethylaminoethyl (meth)acrylate, dimethylaminopropyl (meth)acrylate, diethylaminopropyl (meth)acrylate, dibutylaminoethyl (meth)acrylate, etc.],

dialkyl(C1-4)aminoalkyl(C2-6)(meth)acrylamides [dimethylaminoethyl(meth)acrylamide, dimethylaminopropyl(meth)acrylamide, etc.], N,N-dimethylaminostyrene, N-vinylcarbazole, N-vinylimidazole, 2-vinylpyridine, 4-vinylpyridine, etc.;

(b34) Salts of Amino Group-Containing Monomers:

Salts of the above-mentioned (b31) to (b33) (inorganic salts such as hydrochlorides and phosphates, organic acid salts such as formates and acetates); and

(b35) Quaternary Ammonium Base-Containing Monomers:

Quaternization products derived from the above-mentioned (b33), (a1) or (a2) with a quaternizing agent (C1-12 alkyl chlorides, dialkyl sulfates, dialkyl carbonates, benzyl chloride, etc.), e.g. alkyl (meth)acrylate-derived quaternary ammonium salts [(meth)acryloyloxyethyltrimethylammonium chloride, (meth)acryloyloxyethyltriethylammonium chloride, (meth)acryloyloxyethyldimethylbenzylammonium chloride, (meth)acryloyloxyethylmethylmorpholinium chloride, etc.], alkyl(meth)acrylamide-derived quaternary ammonium salts [(meth)acryloylaminoethyltrimethylammonium chloride, (meth)acryloylaminoethyltriethylammonium chloride, (meth)acryloylaminoethyldimethylbenzylammonium chloride, etc.] and other quaternary ammonium base-containing monomers [dimethyldiallylammonium methyl sulfate, trimethylvinylphenylammonium chloride, etc.].

Preferred among the monomers (b) are (b1), in particular (b12), and (b2), in particular (b21) and (b22). Most preferred are acrylamide, (meth)acrylic acid, and maleic acid (anhydride).

When (A) is a copolymer constituted of two or more monomers (a), the copolymerization ratio (weight ratio) is preferably as follows: monomer (a1) to (a5)/monomer (a6) to (a8)=9/1 to 1/9.

When (A) is a copolymer of (a) and (b), the copolymerization ratio is such that (b) accounts for not more than 60%, preferably 0.1 to 30%, based on the total weight of the monomers (hereinafter “%” means “% by weight” unless otherwise specified).

The number average molecular weight of (A) [as measured by GPC (gel permeation chromatography); hereinafter referred to as “Mn” for short; hereinafter the same shall apply] is generally 1,000 to 5,000,000, preferably 2,000 to 500,000, and especially 100,000 to 500,000.

(A) occurs in the form of an aqueous solution, a lump or a powdery, and the aqueous solution and lump forms are preferred. When it is in the form of a lump or a powder, it is made into an aqueous solution prior to use as a binder.

(A) can be produced by any of the known methods of radical polymerization, for example by solution polymerization, bulk polymerization, emulsion polymerization, or reversed phase suspension polymerization, preferably by solution polymerization (in particular aqueous polymerization) or bulk polymerization. When it is obtained by emulsion polymerization, it can be made into an aqueous solution by neutralizing its ionic groups.

In the case of an aqueous solution, the solid content is generally 5 to 70%, preferably 20 to 40%, and the pH is generally 3 to 12, preferably 6 to 10.

Water-Dispersible Resin (B) Having a Fluorine Atom-Containing Unit, and Other Water-Dispersible Resins (C)

The aqueous dispersion (I) constituting the binder of the present invention may contain (B) and optionally some other water-dispersible resin (C) (constituted of fluorine atom-free monomer units).

In a preferred aspect of the invention, such an aqueous dispersion (I₁) contains (A) and (B) and/or (C).

(B) and (C) are both used as binder constituents of the electrode binder. None of these resins has any heat-reversible thickening ability.

(B) and (C) each can be made into an aqueous dispersion (in the form of an aqueous latex or an aqueous resin powder dispersion, preferably of an aqueous latex) using an aqueous medium, which is to be mentioned later herein, in the step of polymerization or after polymerization.

(B) and (C) each generally has a solubility, in water at 25° C., of not more than 5%, preferably not more than 3%.

(B) and (C) respectively include, among others, vinyl resins [1] [(B[1]) and (C[1])], urethane resins [2] [(B[2]) and (C[2])], polyester resins [3] [(B[3]) and (C[3])], polyamide resins [4] [(B[4]) and (C[4])], epoxy resins [5] [(B[5]) and (C[5])], and polyether resins [6] [(B[6]) and (C[6])]. Preferred among these are [1] from the ease-of-production viewpoint.

The resin (B[1]) is constituted of one or more of fluorine atom-containing vinyl monomers (f), and optionally one or more other monomers.

(f) include monomers (f1) giving a fluoroalkylene group-containing structure to side chains of (B[1]), and monomers (f2) giving a fluoroalkylene group-containing structure to the main chain of (B[1]).

As (f1), there may be mentioned the following: (f11) fluorinated alkyl (C1-18) (meth)acrylates: perfluoroalkyl (meth)acrylates [e.g. perfluorododecyl (meth)acrylate, perfluoro-n-octyl (meth)acrylate, perfluoro-n-butyl (meth)acrylate], perfluoroalkyl-substituted alkyl (meth)acrylates [e.g. perfluorohexylethyl (meth)acrylate, perfluorooctylethyl (meth)acrylate], perfluorooxyalkyl (meth)acrylates [e.g. perfluorododecyloxyethyl (meth)acrylate, perfluorodecyloxyethyl (meth)acrylate, etc.];

(f12) Fluorinated alkyl (C1-18) crotonates;

(f13) Fluorinated alkyl (C1-18) maleates and fumarates;

(f14) Fluorinated alkyl (C1-18) itaconates;

(f15) Fluorinated alkyl-substituted olefins (C2-10 or more; number of fluorine atoms 1 to 17 or more), e.g. perfluorohexylethylene etc.

As (f2), there may be mentioned the following: Fluorinated olefins which contains 2 to 10 or more carbon atoms and 1 to 20 or more fluorine atoms and in which at least one fluorine atom is bound to a carbon atom involved in the double bond; e.g. tetrafluoroethylene, trifluoroethylene, vinylidene fluoride, hexafluoropropylene, etc.

Preferred among (f) in view of their good copolymerizability and ability to readily give stable aqueous dispersion systems are (f1), more preferably (f11), in particular perfluoroalkyl (meth) acrylates. Most preferred is perfluorododecyl (meth)acrylate. With a stable aqueous dispersion system, the electrode material dispersion comprising the binder prepared therefrom will be excellent in applicability.

The ratio of (f) in copolymerization among the constituent monomers of (B[1]) is preferably 1 to 30%, more preferably 2 to 10%, most preferably 3 to 7%. When (f) amounts to 1% or more, the electrode strength tends to improve and, when it is not more than 30%, aqueous dispersions showing good dispersion stability can be obtained without the water repellency of (B[1]) becoming excessively high.

As other monomers, there may be mentioned the above-mentioned (b) and (a).

As the monomers constituting (C[1]), there may be mentioned the above-mentioned (b) and (a).

Preferred among (b) is (b1) when used singly or combinedly with (b2) and/or (b3), in particular (b1) used in combination with (b2). Preferred among (b2) is (b21) [in particular (meth) acrylic acid, among others], (b22) [in particular maleic acid, among others], and/or a salt [in particular ammonium salt, alkali metal salt] thereof.

The ratio (weight ratio) of (b1) or (b1) plus (f)/(b2)/(b3) in copolymerization is preferably 100 to 50/0 to 30/0 to 20, more preferably 99.5 to 70/0.5 to 20/0 to 10, most preferably 99 to 82/1 to 10/0 to 8.

The ratio of the hydrophilic constituent monomers [(b12), (b21) to (b25), (b31) to (b34), etc., and (a)] is not particularly restricted provided that it is within such a range that (B[1]) retains its dispersibility in water. Generally, it is 0 to 20 mole % based on the sum of the monomers.

Preferred among the resins [1] are acrylic resins obtained from constituent monomers mentioned above [among all the monomers, (b11) accounting for not less than 80% (other monomers accounting for not more than 20%)], styrene-acrylic resins [the weight ratio styrene/(b11) being 40 to 60/60 to 40 and these monomers, among all the monomers, accounting for not less than 90% (other monomers accounting for not more than 10%)], styrene-butadiene resins [the weight ratio styrene/butadiene being 30 to 70/70 to 30 and these monomers, among all the monomers, accounting for not less than 80% (other monomers accounting for not more than 20%)], acrylic-butadiene resins [the weight ratio (b11)/butadiene being 30 to 70/70 to 30 and these monomers, among all the monomers, accounting for not less than 80%], acrylonitrile-butadiene resins [the weight ratio acrylonitrile/butadiene being 30 to 70/70 to 30 and these monomers, among all the monomers, accounting for not less than 80%], vinyl acetate resin [among all the monomers, vinyl acetate accounting for not less than 90%], ethylene-vinyl acetate resins [the weight ratio ethylene/vinyl acetate being 20 to 80/80 to 20 and these monomers, among all the monomers, accounting for not less than 90%], ethylene-propylene resins [the weight ratio ethylene/propylene being 20 to 80/80 to 20 and these monomers, among all the monomers, accounting for not less than 90%], polybutadiene resins [among all the monomers, butadiene accounting for not less than 80%], styrene-maleic acid resins [the weight ratio styrene/maleic acid being 40 to 60/60 to 40 and these monomers, among all the monomers, accounting for not less than 70%], modified polystyrene resins [among all the monomers, styrene accounting for not less than 80%, and at least 10% thereof being modified (e.g. sulfonic acid-modified, amino-modified, haloalkyl-modified)], and like resins.

More preferred among these are acrylic resins, styrene-acrylic resins, and styrene-butadiene resins. Most preferred are styrene-butadiene resins.

When the surfactant content in the aqueous phase of the aqueous dispersion comprising [1] is preferably not more than 0.01 millimole/g (resin), because the temperature range from the start of thickening of (A) to gelation can be narrowed. More preferably, the surfactant content is not more than 0.002 millimole/g. The surfactant content is expressed in terms of molar concentration relative to the weight of [1]. The surfactant content in the aqueous phase is determined by diluting the aqueous dispersion containing 50 g of [1] to a concentration of 10%, centrifuging the dilution at 30,000 rpm for 30 minutes for sedimentation, taking 2.0 g of the supernatant and subjecting the same to high-performance liquid chromatography for assaying.

Such aqueous dispersion in which the surfactant content in the aqueous phase is not more than 0.01 millimole/g can be produced, for example, by a method comprising emulsion-polymerizing the monomers using a non-polymerizable surfactant having a low solubility in water [e.g. having an HLB value (as measured by the method of Oda; HLB according to the concept of organicity/inorganicity; value calculated as described in “Shin Kaimen Kassei-zai Nyumon (Introduction of Surfactants, New Edition)”, published by Sanyo Chemical Industries, pages 197-198) of 3 to 9, for example a C22 or higher fatty acid amine or alkali metal salt, a C15 or higher aliphatic or EO (1 to 6 moles) adduct of aromatic alcohol, or the like], a method comprising emulsion-polymerizing the monomers using a polymerizable emulsifier (d), a method comprising emulsion-polymerizing the monomers using a water-soluble polymer as a protective colloid, or the method comprising carrying out (co)polymerization using a monomer having an ion-forming group in an organic solvent, neutralizing the thus-synthesized polymer with an acid or an alkali, then adding water for emulsification and removing the solvent.

Among these methods, the methods involving emulsion polymerization are preferred since they can give aqueous dispersions containing a resin having a high molecular weight. Most preferred is the method comprising emulsion-polymerizing the monomers using a polymerizable emulsifier (d).

As (d), there may be mentioned emulsifiers represented by the following general formula (1):

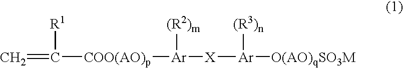

wherein Ar is an aromatic ring; R¹ is H or methyl group; R² and R³ are monovalent hydrocarbon groups, at least one of (m+n) hydrocarbon groups of R² and R³ being aromatic ring-containing hydrocarbon group; m and n are 0 or an integer of 1 to 5, providing an average of (m+n) within the range of 1 to 8; X is covalent bond, an alkylene group, a (cyclo)alkylidene group, an arylalkylidene group, oxygen atom, sulfur atom, sulfonyl group, bistrifluoromethylmethylene group or carbonyl group; M is a cation; A is an alkylene group containing 2 to 4 carbon atoms; and p and q are 1 or an integer of 2 to 40, providing an average of (p+q) within the range of 2 to 80.

As the aromatic ring Ar, there may be mentioned aromatic hydrocarbon rings such as the benzene and naphthalene rings, and hetero atom-containing aromatic rings such as the thiophene and pyrrole rings, among others.

The monovalent hydrocarbon groups R² and R³ include, among others, alkyl groups, for example C1-24 straight or branched alkyl groups (methyl, ethyl, n- and iso-propyl, neopentyl, hexyl, octyl, etc.); alkenyl groups, for example C2-24 straight and branched alkenyl groups (octenyl, nonenyl, decenyl, undecenyl, dodecenyl, etc.); aralkyl groups, for example C7-18 arylalkyl groups (benzyl, 2-phenylethyl, 3-phenylpropyl, etc.); (poly)styryl groups, for example groups resulting from condensation or addition of 1 to 8 styrene molecules; and condensed benzyl groups, for example groups resulting from condensation of 2 to 8 benzyl chloride molecules. Preferred among these are (poly)styryl groups (polymerization degree 1 to 6), benzyl group, condensed benzyl groups (condensation degree 2 to 6), and mixed groups comprising these groups. At least one (preferably 2 to 7) of the (m+n) hydrocarbon groups of R² and R³ are an aromatic ring-containing hydrocarbon group.

m and n each is 0 or an integer of 1 to 5, providing that (m+n) within the range of 1 to 8, preferably 2 to 7. In cases where there are a plurality of R² and/or R³ groups, they may be the same or different. The total number of the aromatic rings (inclusive of Ar) is generally 3 to 16, preferably 4 to 12.

The alkylene group X includes C1-4 ones, for example methylene, ethylene and propylene; the (cyclo) alkylidene group X includes C2-4 ones, for example ethylidene, 2-propylidene, 1-propylidene and cyclohexylidene; and the arylalkylidene group X includes C8-12 ones, for example phenylethylidene.

Preferred among such X species are alkylene groups and alkylidene groups, in particular methylene and 2-propylidene.

M is a cation and includes, among others, metal ions such as alkali metal (e.g. sodium, potassium, lithium) ions, alkaline earth (e.g. magnesium, calcium, barium) ions; ammonium ion; mono- to tetraalkyl-substituted (e.g. C1-8 alkyl-substituted, for example tetramethyl- or tetraethyl-substituted) ammonium ions; and C2-4 hydroxyalkyl-containing alkanolamine (e.g. monoethanolamine, diethanolamine, triethanolamine) ions. Preferred among these are alkali metal ions and the ammonium ion.

The C2-4 alkylene group A includes ethylene, propylene, and 1,2-, 2,3-, 1,3- and 1,4-butylene groups, and combinations of two or more of these. Ethylene, propylene, and combination of these are preferred.

p and q are 1 or an integer of 2 to 40, providing an average of (p+q) within the range of 2 to 80, preferably 5 to 60, more preferably 15 to 40.

In cases where either of R² and R³ is an aromatic ring-containing hydrocarbon group, good emulsion stability can be attained and the particle size of the resulting aqueous dispersion can readily be optimized in the step of radical polymerization. When the average of (p+q) is 5 to 60, the level of hydrophobicity or hydrophilicity may be appropriate, the monomers tend to show good emulsion stability in the step of emulsion polymerization, and the particle size of the resulting aqueous dispersion can readily be optimized.

As examples of the emulsifier of general formula (1), there may be mentioned bis (polyoxyalkylene-polycyclic phenyl ether) monomethacrylate sulfate ester salts (the polycyclic phenyl moiety generally comprising, in total, 3 to 10 polycyclic moiety aromatic rings).

The bis(polyoxyalkylene-polycyclic phenyl ether) includes, among others,

(p1) AO (C2-4) adducts derived from polycyclic phenol (e.g. styrenated phenol, benzylated phenol)-formaldehyde condensates (in this case, the number of moles of styrene or benzyl added is 0.2 to 4 on an average per phenol ring and, structurally, each styrene molecule or benzyl group may be added directly to the phenol ring or one or more further styrene molecules or benzyl groups may be added to the styrene molecule or benzyl group already added to the phenol ring); and

(p2) AO (C2-4) adducts derived from dihydric phenols such as bisphenols (e.g. C-alkyl-substituted bisphenol, halogenated bisphenol, bisphenol F, bisphenol A, cyclohexylenebisphenol, bistrifluoromethylmethylenebisphenol (bisphenol AF), bisphenol S, bisphenol AD, etc.), dihydroxydiphenyl and dihydroxybenzophenone, after styrenation or benzylation thereof in the same manner as mentioned above.

In the case of (p1), condensation products containing three or more nuclei may be produced as byproducts and, thus, monomethacrylate sulfate ester salts other than those of general formula (1) maybe formed. The emulsifier (d) according to the present invention includes these byproducts as well.

As typical examples of (d) represented by the general formula (1), there may be mentioned, among others,

(d1) those in which R¹ is a methyl group; R² and R³ each is a styryl group; Ar is a benzene ring; X is a methylene group; (m+n) is 2 to 6, providing an average thereof being 5; A is an ethylene group; M is an ammonium; and (p+q) is 23 to 25, providing an average thereof being 24;

(d2) those in which R¹ is a methyl group; R² and R³ each is a benzyl group; Ar is a benzene ring; X is a methylene group; (m+n) is 4 to 6, providing an average thereof being 5; A is an ethylene group; M is an ammonium; and (p+q) is 20 to 24, providing an average thereof being 22;

(d3) those in which R¹ is a methyl group; R² and R³ each is a styryl or benzyl group, with the styryl group/benzyl group mole ratio being 1/1; Ar is a benzene ring; X is a methylene group; (m+n) is 5 to 7, providing an average thereof being 6; A is an ethylene or propylene group to form a random copolymer composed of 19 ethylene groups on an average and 4 propylene groups on an average; M is an ammonium; and (p+q) is 20 to 24, providing an average thereof being 23; and

(d4) those in which R¹ is a methyl group; R² and R³ each is a styryl group; Ar is a benzene ring; X is a methylene group; (m+n) is 5 to 6, providing an average thereof being 5.5; A is an ethylene group; M is an ammonium and (p+q) is 55 to 60, providing an average thereof being 58.

As for the method of producing the emulsifiers of general formula (1), there may be mentioned, among others, the method comprising subjecting a polycyclic phenol and formaldehyde to condensation (average degree of condensation=2), then subjecting an AO or AOs to addition reaction to the condensate, esterifying the adduct by dehydration with (meth) acrylic acid, and sulfating the ester with a conventional sulfating agent, where necessary followed by neutralization, as described in Japanese Patent Publication Hei-06-62685. In the above method of production, the polycyclic phenol is, for example a styrenated phenol with 1 to 5 moles of styrene added. The AO may be EO, PO or the like, and the number of moles of the AO added is 2 to 80. The sulfating agent may be chlorosulfonic acid, sulfuric acid anhydride, or sulfamic acid, for instance.

As other emulsifiers (d), there may be mentioned, among others,

(d5) compounds represented by the following general formula (2):

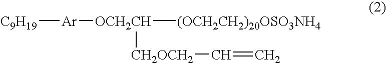

[wherein Ar represents a benzene ring],

compounds represented by CH₂═C(R¹)COO(CH₂)ₘSO₂M, CH₂═C(R¹)COO(AO)ₚSO₃M, or CH₂═C(R¹)COO(AO)ₚCH₂COOM [wherein R¹ represents a hydrogen atom or a methyl group, m represents an integer of 1 to 24, A represents an alkylene group containing 2 to 4 carbon atoms, p represents an integer of 2 to 200, and M represents an alkali metal ion, an ammonium ion or an aminium ion], for example (d6) sodium acryloylpolyoxypropylene [polymerization degree=12] sulfate, and polymerizable emulsifiers described in Japanese Kokai Publication Hei-09-25454.

Preferred among the emulsifiers (d) are those of general formula (1), in particular the emulsifiers (d1), in view of their good copolymerizability with various monomers, in particular styrene.

Generally, (d) is used in an amount of 0.1 to 20%, preferably 1 to 10%, in particular 4 to 8%, based on the weight of (b).

In producing the aqueous dispersion [1] by emulsion polymerization, any known polymerization initiator may be used and, if necessary, a chain transfer agent, a chelating agent, a pH buffering agent and/or the like may be used.

Usable as the polymerization initiator are organic polymerization initiators [peroxides (e.g. cumene hydroperoxide, diisopropylbenzene hydroperoxide, paramethane hydroperoxide, benzoyl peroxide, lauroyl peroxide), azo compounds (e.g. azobisisobutyronitrile, azobisisovaleronitrile)], and inorganic polymerization initiators [persulfates (e.g. sodium persulfate, ammonium persulfate, potassium persulfate), hydrogen peroxide, etc.]. Usable as redox system polymerization initiators are combinations of a persulfate salt and/or a peroxide as an oxidizing agent and sodium hydrogenpyrosulfite, sodium sulfite, sodium hydrogen sulfate, ferrous sulfate, glucose, formaldehyde sodium sulfoxylate and/or L-ascorbic acid, for instance, as a reducing agent. Preferred are inorganic polymerization initiators, in particularly persulfate salts. Generally, the polymerization initiator is used in an amount of 0.01 to 5%, preferably 0.1 to 3%, in particular 1 to 2%, based on the weight of all the monomers.

Usable as the chain transfer agent are a-methylstyrene dimers (2,4-diphenyl-4-methyl-1-pentene etc.), terpinolene, terpinene, dipentene, C8-18 alkylmercaptans, C8-18 alkylenedithiols, alkyl thioglycolates, dialkylxanthogen disulfides, tetraalkylthiuram disulfides, chloroform, carbon tetrachloride, etc. Preferred are C8-18 alkylmercpatans. Most preferred is laurylmercaptan.

These may be used singly or two or more of them may be used in combination. Generally, the chain transfer agent is used in an amount of 0 to 15%, preferably 0.05 to 5%, based on the weight of (b).

Usable as the chelating agent are glycine, alanine, sodium ethylenediaminetetraacetatate, etc. Usable as the pH buffering agent are sodium tripolyphosphate, potassium tetrapolyphosphate, etc. The chelating agent and/or pH buffering agent is used generally in an amount of 0 to 5%, preferably 0 to 3%, in particular 1 to 2%, based on the weight of (b).

The pH is preferably within the range of 5 to 9.

The vinyl resins [1] generally have an Mn of 2,000 to 5,000,000, preferably 3,000 to 2,000,000. The Mn of [1] is determined by subjecting only the soluble fraction obtained after removal of the insoluble matter in toluene insoluble matter determination, as mentioned later herein, to Mn measurement.

The urethane resins [2] [(B[2])₁ (C[2])] are prepared by reacting an organic polyisocyanate (u1) with an active hydrogen atom-containing component (u2).

As (u1), there may be mentioned, among others, C6-20 (exclusive of the NCO group carbon atoms) aromatic poly(di, tri, or poly)isocyanates [e.g. 2,4- and/or 2,6-tolylene diisocyanate (TDI), 4,4′- and/or 2,4′-diphenylmethanediisocyanate (MDI), crude MDI, etc.], C4-15 alicyclic polyisocyanates [e.g. isophoronediisocyanate (IPDI), dicyclohexylmethane-4,4′-diisocyanate (hydrogenated MDI), etc.], C2-18 aliphatic polyisocyanates [e.g. ethylene diisocyanate, tetramethylene diisocyanate, hexamethylene diisocyanate, lysinediisocyanate, etc.], C8-15 araliphatic polyisocyanates [xylylene diisocyanate (XDI) etc.], and modifications [e.g. urethane, carbodiimide, allophanate, urea, biuret, isocyanurate and/or oxazolidone group-containing modifications] of these polyisocyanates.

The component (u2) includes polyols (u21), polyamines (u22), and other active hydrogen atom-containing components (u23).

The polyols (u21) include low-molecular polyols (u211) and high-molecular polyols (u212).

Included among (u211) are C2-12 low-molecular diols (u2111) and tri- to octa- or higher polyhydric C2-18 low-molecular polyols (u2112).

As (u2111), there may be mentioned ethylene glycol, diethylene glycol, propylene glycol, dipropylene glycol, 1,4-butanediol, 1,3-butanediol, 3-methyl-1,5-pentanediol, 1,6-hexanediol, neopentyl glycol, 2-methyl-1,8-octanediol, 1,9-nonanediol, cyclohexanedimethanol, bishydroxyethoxybenzene and the like. As (u2112), there may be mentioned glycerol, trimethylolpropane, pentaerythritol and the like. Low mole AO adducts (OH equivalent less than 300; OH equivalent=Mn per hydroxyl group) of these as well as mixtures of two or more of such polyols and/or such adducts may also be used.

Included among (u212) are polyether polyols (u2121), polyester polyols (u2122), polyolefin polyols (u2123), polymer polyols (u2124), and mixtures of two or more of these.

Included among (u2121) are AO adducts of initiators containing 2 to 8 or more active hydrogen atoms and coupling product derived therefrom by reaction with an alkylene dihalide (C1-4, e.g. methylene dichloride). Included among AOs are those mentioned hereinabove referring to (pl), C5-12 or higher ones (e.g. a-olefin oxides and styrene oxide), epihalohydrins (epichlorohydrin etc.), and combinations of two or more of these (random addition and/or block addition).

Usable as the initiators are the above-mentioned polyols (u211), polyhydric phenols [those bisphenols mentioned hereinabove referring to (p2), hydroquinone, catechol, resorcinol, etc.], and amines.

Specific examples of (u2121) are polyoxyethylene polyols, polyoxypropylene polyols, polyoxyethylenepropylene polyols, EO and/or PO adducts derived from bisphenols, among others.

Included among (u2122) are condensed type polyester polyols, polylactone polyols, castor oil-based polyols, and polycarbonate polyols.

As the condensed type polyester polyols, there may be mentioned, among others, polycondensation products derived from polyols [(u211) and/or (u2121)] and a polycarboxylic acid (c1) and, as the polylactone polyols and polycarbonate polyols, there may be mentioned products derived from (u211) and/or (u2121) by polyaddition of a lactone (c2) or an alkylene carbonate (c3).

As the castor oil-based polyols, there may be mentioned castor oil, products of transesterification between castor oil and (u211) and/or (u2121), and EO (4 to 30 moles) adducts of castor oil, among others.

As (c1), there may be mentioned, among others, C2-24 aliphatic or alicyclic dicarboxylic acids [e.g. oxalic acid, succinic acid, malonic acid, adipic acid, glutaric acid, azelaic acid, sebacic acid, hexahydrophthalic acid, nadic acid, maleic acid, fumaric acid, itaconic acid, tetrahydrophthalic acid, etc.]; C8-18 aromatic dicarboxylic acids [e.g. phthalic acid, isophthalic acid, terephthalic acid, etc.]; C8-18 tri-, tetra- or further polybasic aliphatic or alicyclic polycarboxylic acids [e.g. methylcyclohexenetricarboxylic acid, cyclopentanetetracarboxylic acid, butanetetracarboxylic acid, etc.]; C9-18 tri-, tetra- or further polybasic aromatic polycarboxylic acids [e.g. trimellitic acid, pyromellitic acid, benzophenonetetracarboxylic acid, etc.]; ester-forming derivatives of these [e.g. acid anhydrides, lower alkyl (C1-4) esters, etc.]; and combinations of two or more of these. Preferred among them are aliphatic dicarboxylic acids, aromatic dicarboxylic acids, tri-, tetra- or further higher aromatic polycarboxylic acids (anhydrides), and combinations of two or more of these. More preferred are aliphatic dicarboxylic acids, di- to tetrabasic aromatic polycarboxylic acids, and combinations of these.

As (c2), there may be mentioned C4-12 lactones, for example 4-butanolide, 5-pentanolide and 6-hexanolide, among others. As (c3), there may be mentioned C2-8 alkylene carbonates, such as ethylene carbonate and propylene carbonate, among others.

As typical examples of (u2122), there may be mentioned, among others, polyethylene adipate diol, polybutylene adipate diol, polyethylenebutylene adipate diol, polyneopentyl adipate diol, polyneopentyl terephthalate diol, poly(3-methylpentylene adipate) diol, polycaprolactone diol, polyvalerolactone diol, polyhexamethylene carbonate diol, etc.

As (u2123), there may be mentioned polyalkadiene polyols, for example 1,2- and/or 1,4-polybutadiene diol, hydrogenated polybutadiene diol, etc.; acrylic polyols, for example copolymers of hydroxyethyl (meth) acrylate and another monomer or monomers [e.g. styrene, alkyl (C1-8) (meth)acrylate].

As (u2124), there may be mentioned, among others, dispersions of radical polymers (polymer content generally 5 to 30%) produced by radical polymerization of a radical-polymerizable monomer(s) [e.g. styrene, (meth)acrylonitrile, (meth)acrylate ester, vinyl chloride, a mixture of two or more of these, etc.] in (u2121) and/or (u2122), optionally plus (u211).

The OH equivalent (Mn per hydroxyl group) of (u212) is generally 300 to 6,000, preferably 400 to 5,000. When it is not less than 300, the resulting polyurethane resins have flexibility and, when it is not more than 6,000, the resins will not be too soft and can exhibit a sufficient level of strength.

The OH equivalent of (u211) is generally not less than 30 but less than 300.

Preferably, (u212) and (u211) are used in combination. When they are used combinedly, the weight ratio (u211)/(u212) is preferably 1/100 to 20/80, more preferably 5/95 to 15/85.

Included among (u22) are diamines (u221) and tri- or further polyamines (u222).

Usable as (u221) are C2-16 aliphatic diamines (ethylenediamine, hexamethylenediamine, etc.), alicyclic diamines (isophoronediamine, 4,4′-dicyclohexylmethanediamine, etc.), aromatic diamines (4,4′-diaminodiphenylmethane etc.), araliphatic diamines (xylylenediamine etc.), hydrazine or derivatives thereof (hydrazine, carbodihydrazide, adipic acid dihydrazide, etc.), and blocking products derived from these amine compounds [the blocking agent being a C3-8 ketone (e.g. acetone, methyl ethyl ketone, methyl isobutyl ketone)].

Usable as (u222) are C4-24 aliphatic polyamines (diethylenetriamine, triethylenetetramine, etc.).

Usable as (u23) are C1-12 compound having one active hydrogen atom-containing group (optionally further having a less reactive active hydrogen atom-containing group), for example monoalcohols (methanol, butanol, etc.) and monoamines (butylamine, dibutylamine, mono- and diethanolamine, etc.).

In cases where the urethane resins [2] are (B[2]), at least part of (u1) and/or (u2) is constituted of a fluorine atom-containing component.

The fluorine atom-containing component among (u1) includes fluorine atom-containing polyisocyanates (u1f), for example, 2,2,3,3,4,4,5,5-octafluorohexamethylene diisocyanate, and those described in U.S. Pat. No. 4,994,542, among others.

As the fluorine atom-containing component among (u2), there may be mentioned fluorine atom-containing low-molecular polyols (u211f), fluorine atom-containing polyamines (u22f), and fluorine atom-containing high-molecular polyols (u212f).

As (u211f), there may be mentioned fluoroalkylene group-containing polyols, e.g. HOCH₂CH₂O—(CF₂)ₙ—OCH₂CH₂OH [n=2 to 10], and fluoroalkyl group-containing polyols, e.g. CₙF₂ₙ₊₁—CH(OH)—CH₂—OH [n=2 to 10], among others.

As (u22f), there may be mentioned fluoroalkylene group-containing polyamines, e.g. H₂N—(CF₂)ₙ—NH₂ [n=2 to 10], and fluoroalkyl group-containing polyamines CₙF₂ₙ₊₁—CH(NH₂)—CH₂—NH₂ [n=2 to 10], among others.

As (u212f), there may be mentioned AO adducts (number of moles added 1 to 50) derived from (u211f) or (u22f), polyester polyols derived from (u211f) and (c1), and polyester polyols derived from a fluoroalkylene group-containing dicarboxylic acid(s) (c1f), for example HOOC—(CF₂)—COOH [n=2 to 10], and (u211).

Preferred are (u211f), in particular CₙF₂ₙ₊₁—CH (OH)—CH₂—OH capable of giving resins having side chain fluoroalkyl groups.

The weight proportion of the fluorine atom-containing component(s) in (u1) and (u2) is preferably 0.1 to 20%, more preferably 0.2 to 10%, in particular 1 to 5%.

The aqueous dispersion of [2] includes self-emulsifiable-type aqueous dispersions and emulsifier-emulsified-type aqueous dispersions emulsified using an emulsifier.

Among these, the self-emulsifiable-type ones are preferred since the surfactant amount in the aqueous phase can be reduced.

The self-emulsifiable type [2] can be produced by using, as at least part of (u2), a compound (u2₀) containing a hydrophilic group and an active hydrogen atom-containing group within the molecule.

The hydrophilic group in (u2₀) includes an anionic group, a cationic group, and a nonionic group.

The anionic group includes sulfonic acid, sulfamic acid, phosphoric acid and carboxylic acid groups, and salts of these. The active hydrogen atom-containing group in (u2₀) is, for example, a hydroxyl group, a carboxyl group, or an amino group.

As the sulfonic acid group-containing compound among the anionic group-containing compounds (u2₀), there may be mentioned sulfonic acid diols [3-(2,3-dihydroxypropoxy)-1-propanesulfonic acid etc.], sulfopolycarboxylic acids [sulfoisophthalic acid, sulfosuccinic acid, etc.], and aminosulfonic acids [2-aminoethanesulfonic acid, 3-aminopropanesulfonic acid, etc.]. As the sulfamic acid group-containing compound, there may be mentioned sulfamic acid diols [N,N-bis(2-hydroxyalkyl)sulfamic acid (each alkyl group containing 1 to 6 carbon atoms) or AO adducts thereof (the AO being EO or PO, for instance, the number of moles of AO added being 1 to 6): e.g. N,N-bis(2-hydroxyethyl)sulfamic acid and P0 (2 moles) adducts of N,N-bis (2-hydroxyethyl) sulfamic acid, etc.].

As the phosphoric acid group-containing compound, there may be mentioned bis (2-hydroxyethyl) phosphate, for instance.

The carboxyl group-containing compound includes dialkylolalkanoic acids [e.g. 2,2-dimethylolpropionic acid (DMPA), 2,2-dimethylolbutanoic acid, 2,2-dimethylolheptanoic acid, 2,2-dimethyloloctanoic acid, etc.] and amino acids (2-aminoethanoic acid etc.).

As the salts of these, there maybe mentioned, among others, salts with amines (triethylamine, alkanolamines, morpholine, etc.) and/or alkali metal hydroxides (sodium hydroxide etc.).

Preferred among these are those compounds which have a sulfonic acid or carboxylic acid group as the hydrophilic group, in particular sulfamic acid diols and dialkylolalkanoic acids (in particular 2,2-dimethylolpropionic acid).

As the cationic group-containing (u2₀), there may be mentioned, among others, products of neutralization with an acid (e.g. acetic acid) or quaternization with a quaternizing agent (e.g. dimethyl sulfate) of tertiary or quaternary nitrogen atom-containing monools and polyols, for example N-methyldiethanolamine, N,N-dimethylethanolamine, and the like.

As specific examples of [2] produced by using an ionic group (anionic or cationic group)-containing (u2₀), there may be mentioned those described in Japanese Kokoku Publication Sho-42-24192 and Sho-43-9076.

As (u2₀) having a nonionic group as the hydrophilic group, there may be mentioned polyethylene glycol and polyethylenepropylene glycol (Mn=100 to 3,000), among others.

Preferred as (u2₀) are those having an anionic group as the hydrophilic group and, when this is used in combination, the combined use of a nonionic group-containing one is preferred.

The Mn, per active hydrogen atom, of (u2₀) is preferably less than 300, in particular 50 to 100, when (u2₀) contains an ionic group as the hydrophilic group, and, in the case of non-ionic group-containing ones, it is preferably 50 to 1,500, in particular 700 to 1,000.

As for the equivalent of (u2₀), which constitutes a self-emulsifiable [2], the hydrophilic group preferably amounts to 0.01 to 2 milliequivalents/gram, more preferably 0.1 to 1 milliequivalents/gram, based on the weight of [2] when (u2₀) is an ionic compound. When (u2₀) is a nonionic compound, the weight of the hydrophilic group preferably amounts to 3 to 30% [inclusive of the weight of a polyoxyethylene chain(s) (the number of moles of ethylene oxide added being not less than 2) when (u2121) or (u2122) containing such chain(s) is used], more preferably 5 to 20%, based on the weight of [2].

As for the method of producing aqueous dispersions of [2] of the self-emulsifiable type, there may be mentioned, for example, the method comprising producing an NCO-terminated urethane prepolymer in a one-step or multi-step process by charging (u1), (u2), and optionally a terminator (e), in the presence or absence of an organic solvent, then rendering the prepolymer hydrophilic (by neutralization or quaternization) using a base [where (u2₀) is an anionic compound] or an acid or a quaternizing agent [where (u2₀) is a cationic compound], and, after or during such treatment for rendering the prepolymer hydrophilic, adding an aqueous solution optionally containing a chain extender (k), a crosslinking agent (h) and/or a terminator (e) generally at 10° C. to 60° C., preferably 20° C. to 40° C., to give an aqueous dispersion, and allowing the extension, crosslinking and/or termination reaction to proceed until disappearance of the NCO group, followed by distilling off the organic solvent, if necessary. Rendering hydrophilic (neutralization or quaternization) may be effected after formation of the aqueous dispersion.

In the prepolymer production, the equivalent ratio NCO group/active hydrogen content (exclusive of the carboxyl group) is generally 1.01 to 2, preferably 1.1 to 1.6.

The reaction temperature for prepolymer formation is generally 20° C. to 150° C., preferably 60° C. to 110° C. The reaction time is 2 to 10 hours.

Generally, the end point of prepolymer formation is the time when the free NCO group content becomes 0.5 to 5%.

Usable as the organic solvent are those substantially nonreactive with NCO groups, for example ketones (acetone, methyl ethyl ketone, methyl isobutyl ketone, etc.), esters (ethyl acetate, butyl acetate, ethylcellosolve acetate, etc.), ethers (dioxane, tetrahydrofuran, etc.), hydrocarbons (n-hexane, n-heptane, cyclohexane, tetralin, toluene, xylene, etc.), chlorinated hydrocarbons (dichloroethane, trichloroethane, trichloroethylene, perchloroethylene, etc.), amides (dimethylformamide, dimethylacetamide, etc.), N-methylpyrrolidone and so forth.

Usable as (k) are water, (u2111), (u221), and blocking products derived from these polyamines [the blocking agent being a C3-8 ketone (e.g. acetone, methyl ethyl ketone, methyl isobutyl ketone), a hydrazine derivative (e.g. hydrazine, carbodihydrazide, adipic dihydrazide)].

Usable as (h) are (u222) and (u2112), among others.

The amounts of (k) (except for water) and (h) are generally such that the active hydrogen atom-containing groups (e.g. primary and secondary amino groups) of (k) and (h) generally amount to 0.5 to 2 equivalents, preferably 0.9 to 1.2 equivalents, per equivalent of the prepolymer NCO group.

Usable as (e) are, for example, (u23) and the like.

The terminator (e) is used generally in an amount such that the active hydrogen atom-containing group of (e) as subjected to termination reaction amounts to 0.5 to 2 equivalents, preferably 0.9 to 1.2 equivalents, per equivalent of the NCO group in the prepolymer.

The polyester resins [3] [(B[3]), (C[3])] include polycondensates from a polyol (s) and a polycarboxylic acid(s), and polylactones [lactone adducts to polyols].

In (B[3]), at least part of the polyol(s) and/or polycarboxylic acid(s) is the above-mentioned (u211f) and/or (c1f).

The weight proportion of (u211f) and/or (c1f) in (B[3]) is preferably 0.1 to 20%, more preferably 0.2 to 10%.

As the polyol, there may be mentioned the same species as mentioned hereinabove referring to (u21). Preferred among these are aliphatic dihydric alcohols, aliphatic trihydric alcohols, aliphatic tetrahydric alcohols, and combinations of two or more of these (in particular combinations of a dihydric alcohol and a trihydric alcohol and/or a tetrahydric alcohol). More preferred are combinations of a dihydric alcohol selected from among neopentyl glycol, 2-butyl-2-ethyl-1, 3-propanediol and 1,6-hexanediol, with trimethylolpropane and/or pentaerythritol. In the case of combined use, the weight ratio between the dihydric alcohol and the trihydric alcohol and/or tetrahydric alcohol is preferably (99.5:0.5) to (70:30), in particular (98:2) to (80:20).

The polycarboxylic acid and lactone include the same species as mentioned hereinabove referring to (cl) and (c2), respectively.

Preferred among these are aliphatic dicarboxylic acids, aromatic dicarboxylic acids, tri-, tetra- or further polybasic aromatic polycarboxylic acids (anhydrides), and combinations of two or more of these. More preferred are aliphatic dicarboxylic acids, aromatic di- to tetra-basic carboxylic acids, and combinations of these. Especially preferred are combinations of adipic acid and/or sebacic acid and an aromatic polycarboxylic acid selected from among isophthalic acid, terephthalic acid and trimellitic acid (anhydride) [weight ratio (20 to 50):(80 to 50)].

The polyols, which constitute self-emulsifiable type [3], can be obtained by using the above-mentioned (u211) in combination with that (u2₀) in which the active hydrogen atom-containing group is a hydroxyl group (e.g. polyethylene glycol, dialkylolalkanoic acids, sulfonic acid diols).

They can also be obtained by using an anionic group (other than carboxyl)-containing polycarboxylic acid [e.g. sulfoisophthalic acid (salt) or an ester forming derivative thereof] combinedly as the polycarboxylic acid.

The method of producing [3] is not particularly restricted, but [3] can be produced by emulsifying a polyester obtained by esterification or transesterification in the conventional manner. The esterification or transesterification is generally carried out at a reaction temperature of 100 to 250° C., if necessary in the presence of a catalyst and/or a solvent conventionally used in polyesterification reactions. The catalyst includes, among others, dibutyltin dilaurate, stannous octylate, para-toluenesulfonic acid, lithium naphthenate and the like, and the solvent includes aromatic solvents [toluene, xylene, etc.] and ketone solvents [acetone, methyl ethyl ketone, methyl isobutyl ketone, etc.].

The polyamide resins [4] [(B[4]), (C[4])] include polycarboxylic acid-polyamine condensates, and polylactams (lactam adducts of polycarboxylic acid and/or polyamine).

As the polycarboxylic acid, there may be mentioned the same species as mentioned hereinabove referring to (c1).

As the polyamine, there may be mentioned the same species as mentioned hereinabove referring to (u22).

In (B[4]), at least part of the polycarboxylic acid and/or polyamine comprises the above-mentioned (c1f) and/or (u22f). In this case, the weight proportion of (c1f) and/or (u22f) in [4] is preferably 0.1 to 20%, more preferably 0.2 to 10%.

As the lactam, there may be mentioned C4-12 lactams, for example caprolactam.

The self-emulsifiable type [4] can be obtained by combinedly using, as the polycarboxylic acid, one of the above-mentioned (u2₀) species in which the active hydrogen atom-containing group is a carboxylic acid group or an ester forming modification thereof [sulfopolycarboxylic acid (e.g. sulfoisophthalic acid, sulfosuccinic acid)], for instance.

The epoxy resins [5] [(B[5]), (C[5])] include resins (having an epoxy equivalent of 180 to 3, 000 eq/g) obtained by reacting an epihalohydrin (e.g. epichlorohydrin) with a di- to octa-hydric phenol (e.g. bisphenol A, hydrogenated bisphenol A, phenol novolak) or polyamines having 2 to 6 amino groups [the same ones as mentioned above referring to (u22)] or a di- to tetra-basic polycarboxylic acid [the same ones as mentioned above referring to (c1)] in the presence of an alkali catalyst, and the epoxy resins described in U.S. Pat. No. 5,238,767.

Included among (B[5]) are products obtained by epichlorohydrin with a fluorine atom-substituted di- to octa-hydric phenol (e.g. one derived from bisphenol A by substitution of the isopropylidene group hydrogen atoms for fluorine atoms), the above-mentioned (u22f) and (c1f).

The self-emulsifiable type [5] can be obtained by using, as part of the polyamine, a (u2₀) species in which the active hydrogen-containing group is an amino group or, as part of the polycarboxylic acid, a (u2₀) species in which the active hydrogen-containing group is a carboxyl group.

The polyether resins [6] [(B[6]), (C[6])] include resins obtained by subjecting the same AO as mentioned above referring to (u2121) to ring opening polymerization in the presence of an alkali or acid catalyst. Where necessary, the polymerization can be carried out in the presence of the same initiator as mentioned hereinabove referring to (u2121).

Included among (B [6]) are resins obtained by ring opening polymerization of an AO composition at least partly comprising a fluorine atom-substituted AO (e.g. epifluorohydrin), for instance.

The self-emulsifiable type [6] can be obtained by introduction of a polyoxyethylene chain (e.g. by blockwise addition of EO) and introduction of an ionic group (ionic group introduction by using an amine as the initiator and thereafter converting the amino group to a quaternary ammonium salt).

Preferred among [2] to [6] are the self-emulsifiable ones, like in the case of [1], since the surfactant amount in the aqueous phase can be reduced.

The preferred equivalent or weight proportions of the hydrophilic groups in the self-emulsifiable type [2] to [6] are the same as in the case of [1].

In the practice of the present invention, the aqueous dispersion of the self-emulsifiable (B) or (C) can be produced, for example, by the following methods.

(1) The method comprising grinding the resin component to a size of 10 μm or less, preferably 3 μm or less, in a ball mill, for instance, and then dispersing the ground material in an aqueous solution of a protective colloid such as polyvinyl alcohol or a polyacrylic acid salt;

(2) The method comprising dissolving the resin component in a solvent, adding the solution to an aqueous solution of a protective colloid such as polyvinyl alcohol or a polyacrylic acid salt, and mechanically emulsifying the mixture to a size of 10 μm or less, preferably 3 μm or less, using a high-pressure homogenizer or a vortex mixer, followed by distilling off the solvent.

In these cases, it is preferred that the surfactant content in the aqueous phase of the aqueous dispersion of (B) or (C) be substantially nil or not more than 0.01 millimole/gram (resin).

The Mn of [2] to [4] and [6] is preferably not less than 1,000, more preferably 10,000 to 1,000,000, in particular 30,000 to 70,000. The Mn of [5] is preferably not less than 300, more preferably 300 to 2,000, in particular 1,000 to 1,500. The Mn is an Mn of the toluene-soluble fraction alone after removal of the toluene-insoluble matter, as described below.

The toluene-insoluble matter contents of (B) and (C) are preferably 5 to 95%, more preferably 30 to 80%. The toluene-insoluble matter content is the content of the toluene-insoluble matter in the dried resin, and can be calculated by the formula given below after drying the aqueous dispersion of (B) or (C) under reduced pressure, allowing the film obtained to stand in toluene for dissolution and, after filtration, weighing the insoluble residue.

More specifically, the aqueous dispersion is cast onto a glass mold with a thickness of 1 mm and dried under reduced pressure (absolute pressure: 0.1 MPa) at 30° C. for 24 hours to give a film.

About 1 g of the film is accurately weighed and allowed to stand in 400 ml of toluene for 48 hours for dissolution. Then, the insoluble matter collected on a tared filter paper is dried at 30° C. for one day and then weighed.

Toluene-insoluble matter content (%)=[weight of toluene-insoluble matter on filter paper/film weight before dissolution in toluene]×100

The toluene-insoluble matter contents of (B) and (C) can be adjusted through the proportion of the crosslinking component [a polyfunctional polymerizable vinyl monomer (e.g. divinylbenzene, trimethylolpropane triacrylate, methylenebisacrylamide) in the case of [1]; a tri- or further polyfunctional component in the case of [2] to [4] and [6]; an epihalohydrin or the like in the case of [5]], or by the use of a post-crosslinking agent.

As the post-crosslinking agent that can be used in the case of [2], there may be mentioned aldehyde-containing compounds (formaldehyde, glyoxal, etc.), hydrazine and hydrazine-containing compounds (adipic acid dihydrizide etc.), oxazoline and oxazolidine-containing compounds (2-oxazoline, compounds obtained by heating amide-modified aziridine compounds for cyclization modification, etc.).

The crosslinking agent and/or post-crosslinking agent can be used preferably in an amount of 0.01 to 10%, more preferably 1 to 5%, based on the combined weight of solid matter of (B) and (C).

The glass transition temperature (Tg) of (B) or (C) is generally −80 to 80° C., preferably −50 to 50° C. The Tg can be determined by subjecting a film with a thickness of about 0.3 mm, as obtained by casting the aqueous dispersion of (B) or (C) onto a glass mold and drying under reduced pressure (absolute pressure: 0.1 MPa) at 30° C. for 8 hours, to measurement on a differential scanning calorimeter (DSC) programmed at 20° C./minute in a nitrogen atmosphere.

The aqueous dispersion of (B) or (C) generally has an average particle size (arithmetic average; measured by the laser Doppler method; hereinafter the same shall apply) of 0.02 to 10 μm, preferably 0.1 to 2 μm, more preferably 0.1 to 1 μm.

The aqueous dispersion of (B) or (C) generally has a solid matter content of 10 to 90%, preferably 30 to 70%, and a pH of 3 to 12, preferably 6 to 10.

Generally used as the aqueous dispersion medium in the aqueous dispersion of (B) or (C) are water and combinations of water and hydrophilic organic solvents [e.g. monohydric alcohols (methanol, ethanol, isopropanol, etc.), glycols (ethylene glycol, propylene glycol, diethylene glycol, etc.), tri- and further polyhydric alcohols (glycerol etc.), cellosolves (ethylene glycol monomethyl ether, ethylene glycol monoethyl ether, etc.)]. Among these, water is preferred and, in cases where a hydrophilic organic solvent is combinedly used, it is generally preferred that the hydrophilic organic solvent be used in an amount of not more than 10% based on the total amount of the dispersion medium.

Binder for Electrode

As regards the method of producing the binder for electrode of the present invention, mention may be made of the following methods 1) to 5).

1) The method comprising mixing, using a mixer, (A) with an aqueous dispersion of (B) and/or (C) at a temperature below T of said (A).

2) The method comprising emulsion-polymerizing a vinyl monomer(s) constituting (A) and a vinyl monomer(s) constituting [1] at a temperature below T of (A).

3) The method comprising emulsion-polymerizing a vinyl monomer(s) constituting [1] in the presence of (A) at a temperature below T of (A).

4) The method comprising dissolving (A) in the dispersion medium water at a temperature below T of (A) in the process of producing an aqueous dispersion of (B) and/or (C), and effecting mechanical emulsification or dispersion at that temperature.

5) The method comprising mixing an aqueous dispersion of (B), if necessary plus (C) using a mixer.

Preferred among these are 1) and 2).

The method 2) includes, among others, the one comprising mixing the monomer(s) constituting [1] with the monomer(s) constituting (A) and subjecting the resulting one monomer composition to emulsion polymerization and the one comprising subjecting the monomer(s) constituting [1] and the monomer(s) constituting (A) separately to emulsion polymerization.

When (A) is used, the content of (A) in the binder of the present invention relative to the sum of (A) and the water-dispersible resin [(B) and/or (C)] on the solid basis is preferably not less than 0.001%, more preferably not less than 0.005%, since the heat-reversible thickening ability is readily expressed at such a level. On the other hand, it is preferably not more than 30%, more preferably not more than 20%, since the binder will not become too high in viscosity, hence is easy to handle, even at temperatures lower by at least 10° C. than the transition temperature of (A)

When (A) is used, the ratio between (B) and (C) is generally such that (B) amounts to 0 to 100%, preferably 0.001 to 100%, more preferably 1 to 100%, most preferably 20 to 99.9%, in particular 50 to 99%, based on the total weight of (B) and (C) on the solid basis.

When (A) is not used, the ratio between (B) and (C) is generally such that (B) amounts to 1 to 100%, preferably 20 to 99.9%, more preferably 50 to 99%, based on the total weight of (B) and (C) on the solid basis.

Where necessary, the binder of the present invention may contain a water-soluble polymer (D) in an amount within the range within which the good applicability of the electrode material dispersion of the present invention will not be sacrificed. (D) has a solubility exceeding 5% in water at 25° C. The Mn of (D) is generally 1,000 to 20,000,000, preferably 5,000 to 5,000,000, more preferably 8,000 to 2,000,000. As specific examples of (D), there may be mentioned polyvinyl alcohol and modifications thereof (modifications of copolymers with an ethylene/vinyl acetate mole ratio=2/98 to 30/70 as resulting from hydrolysis of 1 to 80 mole percent of the vinyl acetate units thereof, 1 to 50% partial acetalization products derived from polyvinyl alcohol, etc), starch and modifications thereof (oxidized starch, phosphorylated starch, cationized starch, etc.), cellulose derivatives (methylcellulose, carboxymethylcellulose, hydroxyethylcellulose, etc.), (co)polymers of (meth)acrylamide and/or (meth)acrylate [(meth)acrylamide polymers, (meth)acrylamide-(meth)acrylic acid salt copolymers, alkyl (C1-4) (meth)acrylate-(meth)acrylic acid salt copolymers, etc.], styrene-maleic acid salt copolymers, Mannich-modified polyacrylamide, formaldehyde resins (urea-formaldehyde resins, melamine-formaldehyde resins, etc.), polyamidepolyamine or dialkylamine-epichlorohydrin copolymers, polyethyleneimine, casein, soybean proteins, synthetic proteins, and mannnan galactan derivatives, among others. The above-mentioned salt includes, among others, alkali metal (sodium, potassium, lithium) salts, ammonium salt, organic amine (mono-, di- or trialkylamine having a C1-12 alkyl group(s)) salts, and quaternary ammonium salts (having C1-8 alkyl groups, with the four alkyl groups being the same or different). Preferred among these are cellulose derivatives, in particular methylcellulose, hydroxyethylcellulose and carboxymethylcellulose.

The content of (D) per 100 parts by weight of the sum of (A), (B) and (C) on the solid basis is generally 0 to 50 parts, preferably 0.1 to 40 parts, more preferably 0.1 to 30 parts, most preferably 1 to 10 parts. In the above and the following description, “part(s)” means “part(s) by weight”.

Electrode Material Dispersion

The electrode material dispersion according to the present invention includes aqueous dispersions of the binder of the invention and an electrode material (E). The material (E) is generally used in a powder or fibrous form. As (E), there may be mentioned one or more members selected from the group consisting of those in general use in producing electrodes for electrochemical devices, for example transition metal chalcogenides, hydrogen-occluded alloys, carbonaceous materials, palladium or salts thereof, and conductive polymers.

The transition metal chalcogenides include MnO₂, MnO₃, V₂O₅, V₆O₁₃, Fe₂O₃, Fe₃O₄, LiNiO₂, LiCoO₂, LiMnO₂, Ag₂O, HgO, CuO, PdO₂, NiOOH, TiS₂, FeS₂, MOS₂, etc.; the hydrogen-occluded alloys include Mg—Ni alloys, La—Ni alloys, Ti—Mn alloys, etc.; the carbonaceous materials include carbon fluoride, acetylene black, graphite, polyacrylonitrile- or pitch-derived carbon fibers in ground form, graphite intercalation compounds such as LiC₆, carbonaceous intercalation compounds, etc.; the palladium or salts thereof include Pd, PdSO₄, etc.; and the conductive polymers include polyacetylene, poly-p-phenylene, polythiophene, polypyrrole, etc.

Preferred among these are transition metal chalcogenides, hydrogen-occluded alloys, carbonaceous materials, and palladium or salts thereof. More preferred are transition metal chalcogenides, in particular lithium-containing compounds such as LiNiO₂, LiCoO₂ and LiMnO₂. When these lithium-containing compounds are used in lithium electrochemical devices, especially good discharge characteristics can be obtained.

When the electrochemical device is a cell, the electrode material powder generally has an average particle diameter of not more than 50 μm, preferably 1 to 20 μm. The powder may have two or more particle size distribution peaks. When two or more such powders are used in combination, they may have identical or different in average particle diameter.

When the electrochemical device is an electric double layer capacitor, the powder generally has an average particle diameter of not more than 10 μm, preferably 1 to 5 μm and includes carbonaceous materials such as powdery active carbon, carbon black, Ketjon black, acetylene black and fibrous active carbon (the fiber length being preferably 1 to 10 mm, the average diameter/length ratio being generally 1/10 to 1/1,000), conductive polymers such as polyacetylene, poly-p-phenylene and polypyrrole, and combinations of two or more of these. Preferred among them are carbonaceous materials.

The level of addition (on the solid basis) of the binder of the present invention is generally not less than 0.1 parts, preferably not less than 5 parts, per 100 parts of (E) since, at such a level, the binder is highly effective and the electrodes produced can retain a sufficient strength for use thereof in electrochemical devices. On the other hand, for the desired effects, such as the formation of voids in sufficient abundance and the improvements in discharge characteristics of the electrochemical devices, to be produced to a satisfactory extent, the addition level is preferably not more than 30 parts, more preferably not more than 10 parts.

The proportions of the components on the solid basis in the electrode material dispersion are generally such that (A) amounts to 0 to 10 parts, preferably 0.00001 to 9 parts, more preferably 0.0001 to 5 parts, the water-dispersible resin [(B) and/or (C)] to 0.07 to 30 parts, preferably 0.09 to 21 parts, more preferably 0.1 to 15 parts, and (D) to 0 to 15 parts, preferably 0.01 to 12 parts, per 100 parts of (E).

The electrode material dispersion generally has a solid content [sum of (A), (B), (C), (D) and (E)] of 40 to 90%, preferably 60 to 80%. It occurs as aqueous dispersion slurry. The dispersion medium in the aqueous dispersion slurry may be water or a combination of water and a hydrophilic organic solvent [e.g. one of those dispersion medium species mentioned above referring to (B) and (C)]. Among these, water is preferred and, when a hydrophilic organic solvent is used combinedly, the hydrophilic organic solvent is preferably used in an amount of not more than 10% based on the total dispersion medium.

Available for the production of the electrode material dispersion of the present invention are the method comprising preparing the binder in advance and then incorporating (E) and the method comprising incorporating the binder components and (E) simultaneously. Either method may be used.

When (A) is included among the binder components, the following methods, for instance, may specifically be mentioned.

a) The method comprising producing the binder in advance by blending (A), (B) and/or (C), water, and optionally (D), at temperature lower by at least 10° C. than T of (A) and then further incorporating (E).

b) The method comprising incorporating (A), (B) and/or (C), (E), water, and optionally (D), each individually, at a temperature lower by at least 10° C. than T of (A), without preparing the binder in advance. The order of addition is optional.

c) The method comprising incorporating water and (E), if necessary together with (D), in the step of producing (A) or (B).

For the blending, any of the conventional mixers, for example a Satake agitator or a propeller plunger can be used.

Among the above methods, a) is preferred.

When (A) is not included among the binder components, a blending temperature of 10 to 60° C., for instance, is selected in the above-mentioned methods.

Generally, the dispersion prepared as mentioned above is further treated in a ball mill, for instance, to give a finer dispersion, which is filtered through a 200 to 400-mesh filtration apparatus (e.g. stainless net) and then defoamed under reduced pressure, whereby the desired electrode material dispersion can be obtained.

Description of Electrodes and Electrochemical Devices

As the method of producing electrodes from the electrode material dispersion which contains (A), there may be mentioned the method comprising molding the dispersion or applying the dispersion to a substrate at a temperature lower by at least 5° C., preferably by 8 to 50° C., more preferably by 10 to 30° C., than T of (A), followed by heating for drying at a temperature higher than T of (A) (higher by at least 5° C. than T).

When (A) is not contained in the dispersion, there may be mentioned the method comprising molding or applying the dispersion at ordinary temperature or under heating, followed by heating for drying.

The substrate to which the dispersion is applied is a current collector material. Usable as the current collector material are aluminum foils, copper foils, nickel foils and the like, the foil thickness being 10 to 10,000 μm.

The means for application includes the use of a coater, such as a doctor blade, air knife, roll, curtain roll, fountain blade or gravure roll.

As for the molding method, there may be mentioned the method comprising molding into sheet forms (20 to 50,000 μm in thickness), for instance, using a molding machine for T die extrusion molding or casting molding, for instance.

As the means for heating, there may be mentioned a hot-air drying oven, an electrically heated oven, an infrared heating oven and other heating ovens.

The binder [when it contains (A)] of the invention becomes thickened in this step of drying. As a result, the volume shrinkage due to drying is suppressed and bulky electrodes with a high void fraction can be obtained.

The electrodes obtained in accordance with the present invention can be used as electrodes in various electrochemical devices. The electrochemical devices include, among others, primary cells (manganese dry cells, alkaline manganese dry cells, graphite fluoride-lithium cells, manganese dioxide-lithium cells, solid electrolyte cells, wet cells, thermal cells, etc.), secondary cells (lead storage cells, nickel-cadmium cells, nickel-hydrogen cells, nickel-iron storage cells, silver oxide-zinc storage cells, manganese dioxide-lithium secondary cells, lithium cobaltate-carbonic acid type secondary cells, vanadium-lithium secondary cells, etc.; those described in U.S. Reissue Pat. No. 33,306, for instance), electric double layer capacitors (e.g. those described in U.S. Pat. No. 5,177,673, U.S. Pat. No. 5,381,303, and U.S. Pat. No. 5,870,275), aluminum electrolytic condenser, etc.

When the electrochemical device is a cell, the electrolyte to be used in the electrochemical device includes lithium salts (LiClO₄, LIBF₄, LiAsF₆, CF₃SO₃Li, LiPF₆, LiAlCl₄, LiI, etc.) and sodium salts (NaClO₄, NaBF₄, NaI, etc.), among others. As the solvent for these electrolytes, there may be mentioned carbonates (ethylene carbonate, propylene carbonate, etc.), ethers (tetrahydrofuran, 2-methyltetrahydrofuran, 1,4-dioxane, anisole, etc.), nitriles (acetonitrile, propionitrile, butyronitrile, benzonirile, etc.), sulfur-containing solvents (dimethyl sulfoxide, dimethylformamide, sulfolane, methylsulfolane, etc.), and phosphate esters (triethyl phosphate, trimethyl phosphate, etc.), among others.

The electrolyte to be used when the electrochemical device is an electric double layer capacitor includes, among others, phosphonium salts [(C₂H₅)₄PBF₄, (C₃H₇)₄PBF₄, (C₄H₉)₄PBF₄, (C₂H₅)₄PCF₃SO₃, etc.], ammonium salts [(C₂H₅)₄NBF₄, (C₃H₇)₄NBF₄, (C₄H₉)₄NBF₄, etc.], the lithium salts mentioned above, and those described in U.S. Pat. No. 5,870,275. As the solvent for these electrolytes, there may be mentioned the same ones as mentioned above.

These electrolytes are used generally in a concentration of 0.1 to 3.0 moles/L.

Other parts necessary for the manufacture of electrochemical devices in which the electrodes of the invention are used generally include separators, current collectors, conductive substrates, terminals, insulators and cell cans, among others.

### BEST MODES FOR CARRYING OUT THE INVENTION

The following examples illustrate the present invention in further detail. They are, however, by no means limitative of the scope of the invention.

The following abbreviations are used to indicate the respective monomers.

| | |
|---|---|
| St: | Styrene |
| MMA: | Methyl methacrylate |
| BMA: | n-Butyl methacrylate |
| OMA: | n-Octyl methacrylate |
| BD: | Butadiene |
| MA: | Methacrylic acid |
| F-12: | Perfluorododecyl methacrylate |
| F-8: | Perfluoro-n-octyl methacrylate |
| F-4: | Perfluoro-n-butyl methacrylate |

### PRODUCTION EXAMPLE 1

### Thickener A1

Morpholinoethyl methacrylate (90 parts), 10 parts of MA and 0.1 parts of 2,2′-azobis(2,4-dimethylvaleronitrile) were placed in an ampule. After freezing and degassing, the ampule was sealed, and the polymerization was effected at 50° C. for 8 hours to give a thickener (A1) (T=65° C.).

The Mn of A1 was 300,000.

### PRODUCTION EXAMPLE 2

### Thickener A2

N-Acryloylpyrrolidine (100 parts) and 1 part of 2,2′-azobis(2,4-dimethylvaleronitrile) were placed in an ampule. After freezing and degassing, the ampule was sealed, and the polymerization was effected at 50° C. for 8 hours to give a thickener (A2) (T=56° C.).

The Mn of A2 was 330,000.

### Production Example 3

A pressure reactor equipped with a stirrer, dropping cylinder, nitrogen gas inlet tube and thermometer was charged with 102 parts of water, 45 parts of St, 9 parts of F-12, 4 parts of MA, 5 parts of a polymerizable emulsifier (d1), 1 part of sodium persulfate and 0.2 parts of laurylmercaptan. The system inside was substituted with nitrogen gas with stirring, 37 parts of BD was then added from the dropping cylinder under pressure, and the reaction was carried out at 50° C. for 30 hours and, further, at 85° C. for 5 hours. Then, the unreacted monomers were stripped off under reduced pressure, and the remainder was adjusted to pH 9.5 with an aqueous solution of sodium hydroxide, whereby an aqueous styrene-butadiene-based resin dispersion (B1) with a solid content of 47.9% and an emulsifier content in aqueous phase of 0.0009 millimole/g (resin) was obtained.

### PRODUCTION EXAMPLES 4 TO 7

Aqueous dispersions B2 to B5 were obtained in the same manner as in Production Example 3 except that the monomers and (d) described in Table 1 were used.

### PRODUCTION EXAMPLE 8

An aqueous acrylic resin dispersion (B6) with a solid content of 47.9% and an emulsifier content in aqueous phase of 0.0018 millimole/g (resin) was obtained in the same manner as in Production Example 3 except that 15 parts of St, 32 parts of BMA, 5 parts of F-8, 39 parts of MMA, 4 parts of MA and 5 parts of a polymerizable emulsifier (d4) were used as the monomers and that the addition of BD under pressure was omitted.

### PRODUCTION EXAMPLES 9 TO 14

Aqueous dispersions B7, B8 and C1 to C4 were obtained in the same manner as in Production Example 3 (when BD was used) or Production Example 8 (when BD was not used) except that the monomers and (d) specified in Table 1 were used.

The solid contents in the aqueous dispersion and emulsifier contents in aqueous phase obtained in the above production examples are shown in Table 1.

### EXAMPLES 1 TO 18 AND COMPARATIVE EXAMPLES 1 TO 3

<Binder Production>

A stainless steel beaker was charged with one of the aqueous dispersions specified in Table 2, if necessary together with a 20% aqueous solution of (A) and/or a 20% aqueous solution of (D), each in an amount specified in Table 2 in terms of part(s), followed by mixing up using a propeller plunger. The binders of Examples 1 to 18 and Comparative Examples 1 to 3 were thus produced.

In Table 2, PEM stands for a polyethylene emulsion [“Chemipearl S-100” (solid content 50%), product of Mitsui Petrochemical], and MC for methylcellulose [“M-10000”, product of Shin-Etsu Chemical].

### EXAMPLES 19 TO 36 and COMPARATIVE EXAMPLES 4 TO 6

<Production of an Electrode Material Dispersion for Lithium Secondary Cell Electrodes>

To the whole amount of each binder obtained as described above were added 100 parts of LiCoO₂ with an average particle diameter of 10 μm, 4 parts of acetylene black with an average particle diameter of 20 μm and 30 parts of water, followed by 30 minutes of agitation at 200 rpm using a propeller plunger to give an electrode material dispersion (s) for cathodes.

Likewise, 100 parts of LiC₆ with an average particle diameter of 10 μm and 30 parts of water were added to the whole amount of each binder obtained as described above, followed by 30 minutes of agitation at 200 rpm using a propeller plunger to give an electrode material dispersion (r) for anodes.

<Manufacture of Lithium Secondary Cell Electrodes>

The above dispersion (s) was applied onto an aluminum foil (5 cm in length×1 cm in width×20 μm in thickness) using a blade coater such that a coating weight would be 250 g/m² at 25° C., and dried for 5 minutes in a hot air drier at a hot air temperature of 120° C., to give an electrode for use as a cathode.

The above dispersion (r) was applied onto a nickel foil (5 cm in length×1 cm in width×20 μm in thickness) using a blade coater such that a coating weight would be 250 g/m² at 25° C., and dried under the same conditions as mentioned above for the cathode, to give an electrode for use as a anode.

<Construction of a Lithium Secondary Cell>

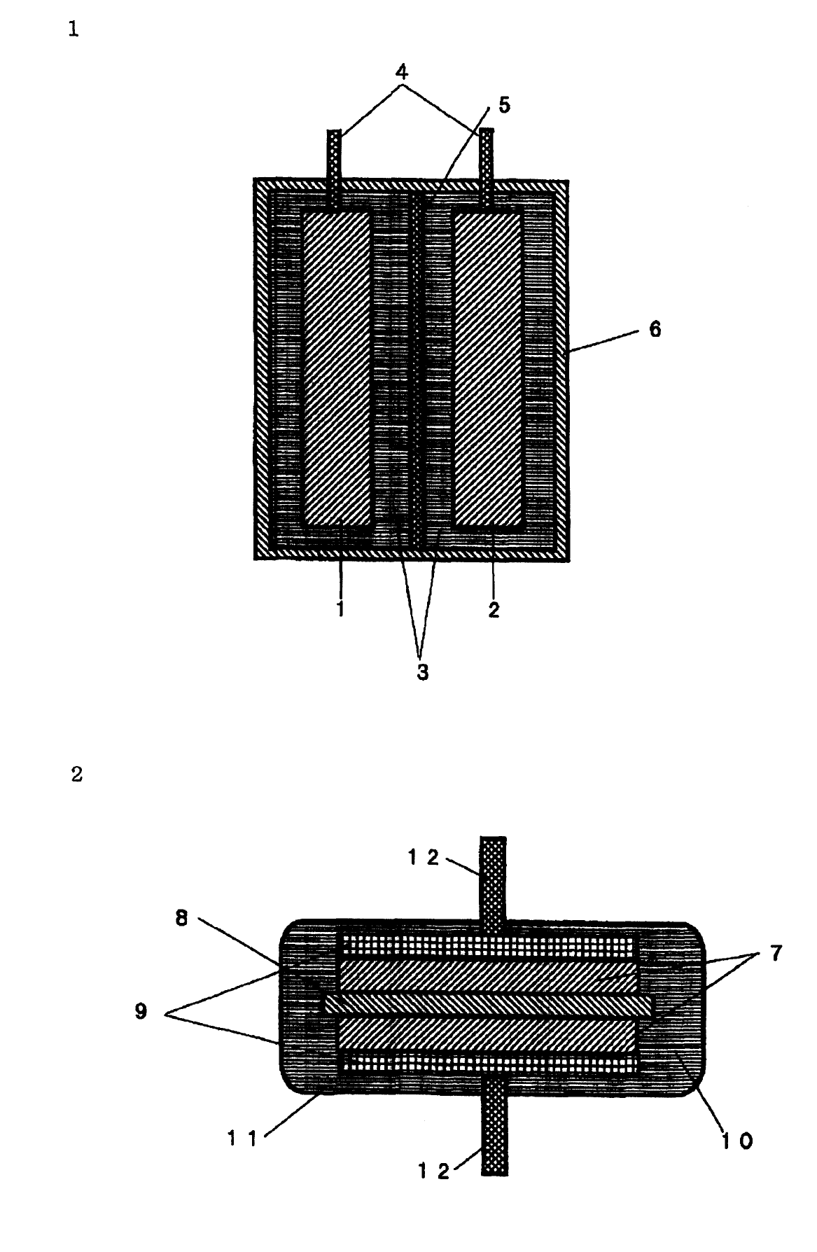

Using the above electrodes, a lithium secondary cell such as shown in FIG. 1 was constructed. Here, a 1 mole/L solution of LiPF₆ in a mixed solvent (mixture of propylene carbonate/ethylene carbonate; mixing weight ratio=5/5) was used as the electrolyte. The separator used was a microporous membrane made of polypropylene, and the current collectors used were aluminum foils.

### EXAMPLES 37 TO 54 and COMPARATIVE EXAMPLES 7 TO 9

<Production of an Electrode Material Dispersion for Electric Double Layer Capacitors>

An electrode material dispersion was produced by adding 100 parts of a petroleum pitch-derived active carbon powder with an average particle diameter of 2 μm, 40 parts of acetylene black with an average particle diameter of 20 μm and 30 parts of water to the whole amount of each binder obtained in the same manner as mentioned above, followed by 30 minutes of stirring at 200 rpm using a propeller plunger.

<Manufacture of Electric Double Layer Capacitor Electrodes>

The above dispersion was applied onto etched aluminum foils (5 cm in length×1 cm in width×20 μm in thickness) using a blade coater so that a coating weight should be 250 g/m² at 25° C., and dried for 5 minutes in a hot air drier at a hot air temperature of 120° C. to give polarizable electrodes for use in electric double layer capacitors.

<Construction of an Electric Double Layer Capacitor>

An electric double layer capacitor such as shown in FIG. 2 was constructed using the above polarizable electrodes. Here, a 1.0 mole/L solution of (C₂H₅)₄PBF₄ in a mixed solvent (mixture of propylene carbonate/ethylene carbonate; mixing weight ratio=5/5) was used as the electrolyte. The separator used was a microporous membrane made of polypropylene.

The void fraction and electrode strength of each electrode obtained in the above examples and comparative examples and the characteristics of each lithium secondary cell or electric double layer capacitor were measured or evaluated by the respective evaluation methods described below. The results thus obtained are shown in Table 3 and Table 4.

Electrode Void Faction Measurement: (for the Lithium Secondary Cell Anode and for the Electric Double Layer Capacitor Polarizable Electrodes)

The amount of mercury that had penetrated under pressure into each electrode obtained was measured using a mercury porosimeter (“PoroSizer 9310”, product of Shimadzu Corp.), and the electrode thickness was measured using a contact type thickness gage (“GS-10”, product of OZAKI MFG. Co.), and the void fraction was calculated as follows.

Void fraction (%)=2×[amount of mercury that had penetrated under pressure (μl)]/[electrode thickness (μm)−20 (μm)]

Electrode Strength: (Measured with the Lithium Secondary Cell Anode)

After 100 repetitions of the charge and discharge cycle, each electrode was taken out, washed with 50 ml of acetone, then air-dried and subjected to a bending test (10 bendings), and the bent portion of the electrode was observed for cracking.

Excellent: No cracking.

Good: 5 to 10% of bent portions showing cracking.

Fair: 30 to 50% of bent portions showing cracking.

Poor: 50% or more of bent portions showing cracking.

Characteristics of Lithium Secondary Cells:

Each lithium secondary cell was charged at a constant current of 0.5 mA and, then, the discharge voltage at the start of discharging and the discharge voltage after 30 hours of discharging were measured. Furthermore, these charge and discharge were repeated and, in each cycle specified in Table 3, the discharge electric capacity was measured.

Characteristics of Electric Double Layer Capacitors:

After discharging of each electric double layer capacitor at a constant current of 1 mA, the electrostatic capacity and internal resistance were measured.

TABLE 1

| | | | | | | | | | | | | | Surfactant |
|---|---|---|---|---|---|---|---|---|---|---|---|---|---|
| | | | | | | | | | | | | | amount in |
| Production | | | | | | | | | | | | Solid | aqueous |
| Example | | Monomer composition | | | | | | | | | | content | phase |
| No. | Binder | St | MMA | BMA | OMA | F-12 | F-8 | F-4 | BD | MA | Emulsifier | (%) | (millimoles/g) |
| 3 | B1 | 45 | | | | 9 | | | 37 | 4 | d1 | 47.9 | 0.0009 |
| 4 | B2 | 45 | 4 | | | 5 | | | 37 | 4 | d1 | 47.9 | 0.0009 |
| 5 | B3 | 45 | 7 | | | 2 | | | 37 | 4 | d1 | 47.8 | 0.0009 |
| 6 | B4 | 45 | 4 | | | 5 | | | 37 | 4 | d2 | 47.9 | 0.0010 |
| 7 | B5 | 45 | 4 | | | 5 | | | 37 | 4 | d3 | 47.9 | 0.0003 |
| 8 | B6 | 15 | 39 | 32 | | | 5 | | | 4 | d1 | 47.9 | 0.0018 |
| 9 | B7 | | 46 | 40 | | | | 5 | | 4 | d4 | 47.9 | 0.0007 |
| 10 | B8 | 45 | 26 | 15 | | | | 5 | | 4 | d5 | 47.9 | 0.0080 |
| 11 | C1 | 45 | 9 | | | | | | 37 | 4 | d1 | 47.9 | 0.0008 |
| 12 | C2 | 15 | 39 | 32 | 5 | | | | | 4 | d1 | 47.9 | 0.0004 |
| 13 | C3 | | 46 | 45 | | | | | | 4 | d4 | 47.9 | 0.0003 |
| 14 | C4 | 45 | 26 | 20 | | | | | | 4 | d5 | 47.9 | 0.0075 |

TABLE 2

| | | | Binder components (parts) | | |
|---|---|---|---|---|---|
| | | Binder | | Aqueous | |
| | | No. | (A) | dispersion | (D) |
| Example | 1 | 1 | A1(0.1) | B1(14) | |
| | 2 | 2 | A1(0.1) | B2(14) | |
| | 3 | 3 | A1(0.1) | B3(14) | |
| | 4 | 4 | A1(0.1) | B2(10) + C1(4) | |
| | 5 | 5 | A1(0.2) | B2(14) | |
| | 6 | 6 | A2(0.1) | B4(14) | |
| | 7 | 7 | A2(0.1) | B5(14) | |
| | 8 | 8 | A2(0.1) | B6(14) | |
| | 9 | 9 | A2(0.1) | B7(14) | |
| | 10 | 10 | A2(0.1) | B8(14) | MC(0.1) |
| | 11 | 11 | A1(0.1) | C1(14) | |
| | 12 | 12 | A1(0.1) | C2(14) | |
| | 13 | 13 | A1(0.1) | C3(14) | |
| | 14 | 14 | A1(0.1) | C4(14) | |
| | 15 | 15 | | B2(14) | |
| | 16 | 16 | | B4(14) | |
| | 17 | 17 | | B2(10) + C1(4) | |
| | 18 | 18 | | B4(10) + C2(4) | |
| Compar. | 1 | X1 | | C1(14) | |
| Example | 2 | X2 | | PEM(14) | |
| | 3 | X3 | | C1(14) | MC(0.5) |

TABLE 3

| | | | | Discharge time and | | Discharge electric | | | |
|---|---|---|---|---|---|---|---|---|---|
| | | | | discharge voltage (V) | | capacity (mAh) in | | | |
| | | | Void | | After 30 | each cycle specified | | | |
| | | Binder | fraction | At start of | hours of | 1st | 50th | 100th | Electrode |
| | | No. | (%) | discharging | discharging | cycle | cycle | cycle | strength |
| Examples | 19 | 1 | 35 | 4.3 | 3.8 | 15.5 | 13.4 | 10.1 | Excellent |
| | 20 | 2 | 36 | 4.5 | 3.8 | 15.7 | 13.7 | 10.4 | Excellent |
| | 21 | 3 | 40 | 4.1 | 3.5 | 15.0 | 13.0 | 9.9 | Excellent |
| | 22 | 4 | 38 | 4.2 | 3.7 | 15.8 | 13.7 | 10.4 | Good |
| | 23 | 5 | 43 | 4.2 | 3.6 | 16.3 | 14.0 | 10.9 | Excellent |
| | 24 | 6 | 33 | 4.4 | 3.7 | 16.0 | 14.0 | 10.3 | Excellent |
| | 25 | 7 | 33 | 4.4 | 3.7 | 16.0 | 14.0 | 10.8 | Excellent |
| | 26 | 8 | 33 | 4.3 | 3.7 | 16.0 | 14.1 | 10.3 | Excellent |
| | 27 | 9 | 36 | 4.5 | 3.8 | 15.7 | 13.7 | 10.4 | Excellent |
| | 28 | 10 | 40 | 4.2 | 3.5 | 15.0 | 13.0 | 9.9 | Excellent |
| | 29 | 11 | 38 | 4.2 | 3.7 | 15.8 | 13.7 | 10.4 | Fair |
| | 30 | 12 | 38 | 4.3 | 3.6 | 16.3 | 14.0 | 10.9 | Fair |
| | 31 | 13 | 33 | 4.4 | 3.6 | 16.2 | 14.0 | 10.3 | Fair |
| | 32 | 14 | 33 | 4.4 | 3.7 | 16.0 | 14.2 | 10.8 | Fair |
| | 33 | 15 | 20 | 3.6 | 3.7 | 16.1 | 14.0 | 10.1 | Excellent |
| | 34 | 16 | 16 | 3.7 | 3.7 | 16.0 | 14.0 | 10.4 | Excellent |
| | 35 | 17 | 15 | 3.9 | 3.7 | 15.9 | 14.0 | 10.8 | Good |
| | 36 | 18 | 17 | 3.8 | 3.7 | 16.0 | 14.2 | 10.1 | Good |
| Compar. | 4 | X1 | 15 | 3.7 | 3.2 | 11.5 | 9.5 | 7.1 | Fair |
| Examples | 5 | X2 | 12 | 3.5 | 2.9 | 10.9 | 9.4 | 7.3 | Fair |
| | 6 | X3 | 20 | 3.9 | 3.3 | 12.0 | 10.8 | 8.5 | Fair |

TABLE 4

| | | | Void | Electrostatic | Internal |
|---|---|---|---|---|---|
| | | Binder | fraction | capacity | resistance |
| | | No. | (%) | (F/g) | (mΩ/cm) |
| Examples | 37 | 1 | 36 | 26 | 34 |
| | 38 | 2 | 35 | 29 | 33 |
| | 39 | 3 | 39 | 27 | 26 |
| | 40 | 4 | 39 | 28 | 27 |
| | 41 | 5 | 41 | 29 | 34 |
| | 42 | 6 | 35 | 29 | 32 |
| | 43 | 7 | 34 | 26 | 34 |
| | 44 | 8 | 35 | 29 | 33 |
| | 45 | 9 | 35 | 26 | 36 |
| | 46 | 10 | 39 | 28 | 27 |
| | 47 | 11 | 38 | 29 | 35 |
| | 48 | 12 | 38 | 29 | 32 |
| | 49 | 13 | 35 | 27 | 26 |
| | 50 | 14 | 36 | 29 | 25 |
| | 51 | 15 | 22 | 13 | 54 |
| | 52 | 16 | 18 | 12 | 52 |
| | 53 | 17 | 16 | 14 | 47 |
| | 54 | 18 | 19 | 13 | 45 |
| Compar. | 7 | X1 | 16 | 12 | 47 |
| Examples | 8 | X2 | 13 | 11 | 51 |
| | 9 | X3 | 19 | 12 | 58 |

### INDUSTRIAL APPLICABILITY

The electrode material dispersion in which the binder of the invention is used shows good applicability in the step of application onto current collectors, hardly allows streaks or the like on the coated surface, and electrochemical devices in which short circuiting hardly occurs and whose life is long can be manufactured by using electrodes produced in that manner.

Furthermore, when the binder of the invention is used, shrinkage upon drying in the process of electrode production hardly occurs but electrodes high in void fraction can be obtained, so that electrochemical devices satisfactory in discharge voltage, discharge electric capacity and electrostatic capacity can be obtained.

Furthermore, electrodes high in electrode strength can be obtained by using the binder of the invention. Therefore, the binder is very effective in making electrochemical devices smaller-sized and prolonging their life.

In addition, the binder of the invention is a water-based one, hence it exerts only slight influence on the environment and is highly safe to the human being.

1. A binder for an electrode material of an electrochemical device,
said binder comprising an aqueous dispersion (I) containing a water-dispersible resin; (I) containing at least one of a thermoreversible thickening vinylic polymer (A) having reversibility of hydrophilicity and hydrophobicity at a certain transition temperature (T) and a water-dispersible resin (B) having a fluorine atom-containing unit.

2. The binder of claim 1,
wherein (B) is a water-dispersible resin having fluoroalkyl group-containing side chains.

3. The binder of claim 1 or 2,
wherein (I) comprising (B) and optionally another water-dispersible resin (C).

4. The binder of any one of claims 1 to 3,
wherein (I) is an aqueous dispersion (II) comprising (A), and (B) and/or (C).

5. The binder of claim 4,
wherein the amount of a surfactant in the aqueous phase of said dispersion of (B) and/or (C) is not higher than 0.01 milli-mole/g (resin).

6. The binder of claim 4 or 5,
wherein said dispersion of (B) and/or (C) is a resin latex obtained using a polymerizable emulsifier (d).

7. The binder of claim 6,
wherein (d) is represented by the following general formula (1): 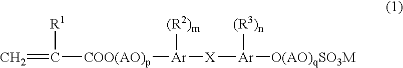
wherein Ar is an aromatic ring; R¹ is H or methyl group; R² and R³ are monovalent hydrocarbon groups, at least one of (m+n) hydrocarbon groups of R² and R³ being aromatic ring-containing hydrocarbon group; m and n are 0 or an integer of 1 to 5, providing an average of (m+n) within the range of 1 to 8; X is covalent bond, an alkylene group, a (cyclo)alkylidene group, an arylalkylidene group, oxygen atom, sulfur atom, sulfonyl group, bistrifluoromethylmethylene group or carbonyl group; M is a cation; A is an alkylene group containing 2 to 4 carbon atoms; and p and q are 1 or an integer of 2 to 40, providing an average of (p+q) within the range of 2 to 80.

8. The binder of any one of claims 4 to 7,
which contains (A) in an amount of 0.001 to 30% by weight, based on the total solid weight of (A) and (B) and/or (C).

9. The binder of any one of claims 4 to 8,
wherein (A) is a (co)polymer of a vinylic monomer (a) providing thermoreversible thickening ability and/or a copolymer of (a) with another monomer (b).

10. The binder of claim 9,
wherein (a) is at least one nitrogen-containing acrylic monomer selected from the group consisting of (meth) acrylates of an alkylene oxide adduct of a cyclic amine, (meth) acrylates of an alkylene oxide adduct of an acyclic amine containing 5 to 18 carbon atoms, N-alkyl- or alkoxyalkyl(meth)acrylamides, N,N′-dialkyl- or dialkoxyalkyl-(meth)acrylamides, and N-(meth)acryloyl heterocyclic amines.

11. The binder of any one of claims 4 to 10,
wherein (A) has T in the range of 30 to 95° C.

12. The binder of any one of claims 1 to 11,
wherein (B) and/or (C) is at least one selected from the group consisting of vinylic resins [1], urethane resins [2], polyester resins [3], polyamide resins [4], epoxy resins [5] and polyether resins [6].

13. The binder of claim 12,
wherein [1] is a (co)polymer of at least one vinylic monomer selected from the group consisting of (meth)acrylic ester monomers, (meth)acrylamide monomers, cyano group-containing monomers, styrenic monomers, diene monomers, alkenyl ester monomers, epoxy group-containing monomers, monoolefins, halogen atom-containing monomers, heterocylcic monomers, unsaturated dibasic acid dialkyl ester monomers, silyl group-containing monomers, anionic monomers and cationic monomers.

14. The binder of any one of claims 1 to 13,
which further contain a water-soluble polymer (D).

15. The binder of claim 14,
wherein (D) is at least one selected from the group consisting of polyvinyl alcohols and modified products thereof, (co)polymers of (meth)acrylamide and/or (meth)acrylic acid salts, styrene-maleic acid salt copolymers, Mannich-modified polyacrylamides, formaldehyde resins, copolymers of epichlorohydrin with a polyamidepolyamine or dialkylamine, polyethylene-imines, starches and modified products thereof and cellulose derivatives.

16. An electrode material dispersion for an electrochemical device,
which comprises a binder of any one of claims 1 to 15 and an electrode material (E).

17. An electrode material dispersion for an electrochemical device,
which comprises a thermoreversible thickening vinylic polymer (A) having reversibility of hydrophilicity and hydrophobicity at a certain transition temperature (T), and a water-dispersible resin (B) having a fluorine atom-containing unit and/or another water-dispersible resin (C) and optionally a water-soluble polymer (D), and an electrode material (E).

18. The electrode material dispersion of claim 16 or 17,
wherein (E) is at least one selected from the group consisting of transition metal chalcogenides, hydrogen-occluded alloys, carboneous materials, palladium or salts thereof and conductive polymers.

19. An electrode for an electrochemical device, formed from the electrode material dispersion of any one of claims 16 to 18.

20. A process for producing an electrode for an electrochemical device,
which comprises molding or applying onto a substrate the electrode material dispersion of any one of claims 16 to 18 at a temperature at least 5° C. lower than T, followed by drying at a temperature higher than T.

21. A primary cell, a secondary cell, an aluminum electrolytic capacitor or an electric double layer capacitor,
which has an electrode according to claim 19 or an electrode produced according to the process of claim 20.
